(19) United States
(12) Patent Application Publication
(10) Pub. No.: US 2009/0028101 A1
(43) Pub. Date: Jan. 29, 2009

(54) AUTHENTICATION METHOD IN A RADIO COMMUNICATION SYSTEM, A RADIO TERMINAL DEVICE AND RADIO BASE STATION USING THE METHOD, A RADIO COMMUNICATION SYSTEM USING THEM, AND A PROGRAM THEREOF

(75) Inventor: Takahiro Kakumaru, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, TOKYO (JP)

(21) Appl. No.: 11/908,361

(22) PCT Filed: Feb. 21, 2006
(86) PCT No.: PCT/JP2006/302995

§ 371 Date: Sep. 11, 2007

(30) Foreign Application Priority Data
Mar. 15, 2005 (JP) 2005-072129

(51) Int. Cl. H04M 1/66

(52) U.S. Cl. 370/329

(57) ABSTRACT

For communication with a base station on an IP network, radio terminals have a function for encapsulating and releasing encapsulation of a packet for preparatory authentication defined in the IEEE 802.11i at a RADIUS client unit by an authentication packet communicable on the IP network. For communication with the radio terminals on the IP network, the base station has a function for encapsulating and releasing encapsulation of a packet for preparatory authentication defined in the IEEE 802.11i at a RADIUS server by an authentication packet communicable on the IP network. Thus, it is possible to provide an authentication method in a radio communication system enabling a preparatory authentication between a radio terminal and a base station even between IP sub-networks. There are also disclosed a radio terminal device and a radio base station using this authentication method, a radio communication system using them, and a program.

### TECHNICAL FIELD

The present invention relates to an authentication method in a radio communication system, a radio terminal device and radio base station that uses this authentication method, a radio communication system that uses them, and a program, and more particularly to an authentication method in a radio communication system, a radio terminal device and radio base station that uses this authentication method, a radio communication system that uses them, and a program that are capable of executing a pre-authentication process in an IP (Internet Protocol) network.

### BACKGROUND ART

Recently, the vulnerabilities of radio LAN security have been pointed out. In other words, the vulnerabilities that there is a possibility that data that has been encrypted using a WEP (Wired Equivalent Privacy) key that is used in a radio LAN will be analyzed, and at the same time, by analyzing the WEP key, all data communication by way of the radio LAN will be analyzed have been pointed out.

In order to eliminate these vulnerabilities as much as possible, the IEEE (Institute of Electrical and Electronic Engineers) 802.11i standard has been set for strengthening IEEE 802.11 radio LAN security. (Refer to IEEE P802.11i/D10.0, “Part 11: Wireless Medium Access Control (MAC) and Physical Layer (PHY) specifications: Amendment 6: Medium Access Control (MAC) Security Enhancements”, USA, 2004, 8.4.6.1 Pre-authentication and RSNA Key Management.)

IEEE 802.11i specifies a data encrypting algorithm for a radio link that strengthens the access control, safe session management, dynamic key exchange and key management, and WEP encoding algorithm based on IEEE 802.1X in order to solve the aforementioned vulnerabilities in a radio link of an IEEE 802.11 radio LAN system. (Refer to IEEE 802.1X, “Port-Based Network Access Control”, USA, 2001, 6. Principles of Operation.”

IEEE 802.1X specifies a framework for user authentication and key exchange. In IEEE 802.11i, 4-way handshake and group-key handshake are defined as new key-exchange methods, and a key hierarchy for setting the use of the key, and an encrypting algorithm for a radio link (CipherSuites) are defined.

FIG. 1 shows the radio LAN connection sequence when normal IEEE 802.11i and IEE 802.1X are used.

As shown in FIG. 1, in order for a radio terminal to become capable of data communication by way of a base station, IEEE 802.11 negotiation (802.11 Authentication, Association), IEEE 802.1X authentication (EAP [Extensible Authentication Protocol] authentication), and IEEE 802.11i key exchange (4-way handshake, group-key handshake) are needed.

By successfully completing IEEE 802.1X authentication, the radio terminal and radio base station share a Pairwise Master Key (hereafter referred to as PMK) that is only known by the base station and authentication server.

This PMK is used for encrypting communication contents and checking for tampering of the communication contents in key exchange, which is a process of setting a key for encrypting data communication between a radio terminal and base station. As a result of IEEE 802.1X authentication, the PMK is shared by both the radio terminal and authentication server, and by the authentication server notifying the base station that authentication was successful, and by both notifying each other of the PMK, the PMK is also shared by the radio terminal and base station.

The radio terminal 1 in the network construction shown in FIG. 2 has mobility, so it can move to a new base station 3 from the currently connected base station 2.

Normally, when the radio terminal is connected to the new base station 3 and tries to receive service that was provided from the previously connected base station 2, connection negotiation with the new base station 3 must be performed again, or in other words, the IEEE 802.11 negotiation, IEEE 802.1X authentication and IEEE 802.11i key exchange sequence is necessary.

However, by performing the aforementioned sequence each time when moving between base stations, communication with the network is interrupted during that time, so the provided service is affected. In order to solve this problem, a method for simplifying the sequence by using a PMK cache is proposed in IEEE 802.11i.

FIG. 3 shows a radio LAN connection sequence when the aforementioned PMK cache is used.

The PMK cache holds the PMK that was acquired by the radio terminal and base station when authentication of the connected base station was successfully completed once, and the held PMK is used when connecting again to the same base station, thus is designed to omit the IEEE 802.1X authentication process.

By having an identifier in an Association Request frame or Reassociation Request frame for identifying the PMK that was previously acquired for the aforementioned base station, the radio terminal notifies the base station that it wants to use the PMK cache.

When the base station that receives the Association Request frame or Reassociation Request frame that contains the identifier for identifying the PMK similarly has a PMK for the radio terminal, it performs the IEEE 802.11i key exchange sequence instead of IEEE 802.1X authentication.

When doing that, by including the selected PMK identifier in the first frame of the IEEE 802.11i key exchange sequence, authentication is performed between the radio terminal and base station.

When there is no PMK for the radio terminal, normal IEE 802.1X authentication starts. By using a PMK cache in this way, the IEEE 802.1X authentication sequence can be omitted.

However, there is a problem with the PMK cache in that the PMK cache is only effective when connecting to a base station with which authentication and connection has successfully been performed once.

In order to partially solve this problem, a method, in which by performing IEEE 802.1X authentication beforehand with the base station to which connection is to be newly performed by way of the currently connected base station and acquiring the PMK, the PMK cache can be used for a base station to which connection has never been performed before, is similarly proposed in IEEE 802.11i as Pre-authentication.

FIG. 4 shows the radio LAN connection sequence when using the aforementioned pre-authentication.

The radio terminal successfully completes authentication with the currently connected base station and is in a state of encoded data communication using a dynamically set key.

In this state, by obtaining a beacon that is sent from the base station to which the radio terminal will newly connect, or in other words, from the base station that is the object of pre-authentication, the radio terminal detects that base station, and starts pre-authentication. This pre-authentication uses IEEE 802.1X protocol and a state machine, and by using 88-C7 as the Ether type for the Ether frame instead of the normal 88-8E, identifies that authentication is pre-authentication.

The base station receives the 88-C7 Ether type frame and transfers the frame to a device holding the MAC address written in the destination address.

Also, the pre-authentication frame specifies the BSSID of the base station that is the object of pre-authentication in the destination address, and by specifying the BSSID of the currently connected base station in the range of the basic service set, the radio terminal is able to perform pre-authentication with the base station that is the object of pre-authentication by way of the currently connected base station.

The BSSID of the base station that is the object of pre-authentication is obtained from a beacon that is sent by the base station that is the object of pre-authentication. Also, the authentication itself is the same as 802.1X authentication, and by successfully completing authentication, the radio terminal and the base station that is the object of pre-authentication share a new PMK. By sharing this PMK, the radio terminal can use the PMK cache for connection negotiation with newly pre-authenticated base station.

However, there is a problem with this pre-authentication in that it can only be applied when the currently connected base station and the base station that is the object of pre-authentication are in a network having the same broadcast domain, or in other words, are in the same IP sub network. That is, pre-authentication cannot be applied when the base station is located beyond the IP sub network.

### DISCLOSURE OF THE INVENTION

### Problems to be Solved by the Invention

There is a first problem in that it is only possible to perform pre-authentication inside the broadcast domain (sub network). The reason for this is that in a conventional pre-authentication system pre-authentication beyond the broadcast domain is not considered.

There is a second problem in that it is not possible for the radio terminal attempting to perform pre-authentication to obtain the IP address for identifying the base station that is the object of pre-authentication. The reason for this is the same as the reason for the first problem.

The object of the present invention is to provide a radio communication system in which pre-authentication can be performed with a base station that is located beyond the broadcast domain to which the base station currently connected to a radio terminal belongs.

Another object of the present invention is to provide a radio communication system in which the period during which data communication is not possible due to the authentication is reduced when the radio terminal moves from the currently connected base station to another base station, even when the new base station belongs to a broadcast domain that is different than the original base station.

Yet another object of the present invention is to provide a radio communication system in which it is possible to dynamically obtain and set information for network connection that includes information for pre-authentication.

### Means for Solving the Problems

The radio communication system of the present invention is an communication system that requires authentication by an authentication server when a radio terminal connects to a network by way of a base station, wherein the radio terminal and the base station comprise means for performing authentication beforehand when the radio terminal attempts to connect to another base station by way of an IP network.

The base station of the present invention is a base station that connects a radio terminal, which requires authentication by an authentication server when connecting to a network, to a network according to authentication results, and comprises means for processing pre-authentication this is performed over an IP network from the radio terminal that is already connected to the network.

The radio terminal of the present invention is a radio terminal that requires authentication from an authentication server when connecting to a network by way of a base station, and comprises means for requesting pre-authentication of a base station that is capable of IP data communication by way of the connected network.

The radio terminal of the present invention also comprises means for acquiring information corresponding to a base station from a base station management server or a setting information server. Also, the radio terminal comprises a plurality of radio communication means.

The base station management server of the present invention is a server that stores IP address information for base stations, and comprises means for returning an IP address of a base station in response to a base station IP address acquisition request from a radio terminal.

The setting information server of the present invention is a server that stores information that is necessary when a radio terminal connects to a radio network, and comprises means for returning information that it stores in response to an acquisition request from a radio terminal.

In other words, when a radio terminal, which requires authentication from an authentication server when connecting to a network by way of a base station, performs pre-authentication of a base station by way of the network to which it is already connected, the radio communication system of this invention solves the problem of performing that pre-authentication by performing the pre-authentication over an IP network.

In the radio communication system of this invention, pre-authentication may be performed from the IP address of the base station that is the object of pre-authentication that is stored by the radio terminal.

Moreover, in the radio communication system of this invention, a base station management server may store IP addresses corresponding to base stations, and pre-authentication may be performed by the radio terminal acquiring the IP address that corresponds to the base station from the base station management server.

Furthermore, in the radio communication system of this invention, a setting information server may store information related to network connection, and pre-authentication may be performed by the radio terminal acquiring setting information from the setting information server, and using that information for network connection and pre-authentication.

The pre-authentication referred to here is pre-authentication that uses an IEEE 802.11i PMK cache, and that shares PMK in advance by performing IEEE 802.1X authentication by way of the currently connected IP network, and then during actual radio LAN connection, the radio LAN connection is performed by simply performing IEEE 802.11 negotiation and key exchange.

This invention comprises: a base station that connects to a network by way of LAN lines or WAN lines, and uses radio waves as a transmission medium; a base station that is similarly connected to a network by way of LAN lines or WAN lines, and uses radio waves as a transmission medium; a radio terminal that performs network connection by way of a base station and LAN lines or WAN lines, and uses radio waves as a transmission medium; and an authentication server that connects to LAN lines or WAN lines and processes authentication requests from a radio terminal by way of a base station.

The radio terminal requires user authentication or mutual authentication in order to connect to a network by way of a base station, and in a radio network system in which authentication can be performed by way of the already connected network, by making it possible for a radio terminal and base station to perform pre-authentication over an IP network, the radio terminal and base station can perform pre-authentication even though they exist in different IP sub networks.

### EFFECT OF THE INVENTION

The effect of the present invention having the forms described above is presented below.

The first effect of the invention is that a radio terminal can perform pre-authentication of a base station in order to use an IEEE 802.11i PMK cache even though the IP sub network is different. As a result, even when a radio terminal that is beyond the IP sub network moves to the base station connected to first, connection negotiation processing can be reduced by using a PMK cache, and thus the time required to wait for connection is also reduced. The reason for that is that the radio terminal and base station comprise authentication protocol processing means capable of IP communication so that the exchange for pre-authentication can be performed over an IP network.

The second effect of the invention is that it is not necessary to set the IP address of the base station that is the object of pre-authentication in the radio terminal in advance. As a result, it is possible to reduce setting mistakes by the user, handle cases in which the IP address of the base station changes, reduce the trouble of having to make many settings. The reason for that is that the radio terminal comprises means capable of dynamically acquiring settings, and it is possible to dynamically acquire settings by making inquiries of the managing server.

### BRIEF DESCRIPTION OF THE DRAWINGS

FIG. 1 is a sequence chart showing the radio LAN connection operation when using conventional IEEE 802.11i and IEEE 802.1X.

FIG. 2 is a block diagram showing the construction of a conventional radio communication system.

FIG. 3 is a sequence chart showing the radio LAN connection operation when using a conventional IEEE 802.11i specification PMK cache.

FIG. 4 is a sequence chart showing the radio LAN connection operation when using conventional IEEE 802.11i specification pre-authentication.

FIG. 5 is a block diagram showing the construction of a radio communication system of a first embodiment of the invention.

FIG. 6 is a block diagram showing the construction of the radio terminal 10-1 that is shown in FIG. 5.

FIG. 7 is a block diagram showing the construction of the base station 30 that is shown in FIG. 5.

FIG. 8 is a sequence chart showing the operation of a first embodiment of the invention.

FIG. 9 is a block diagram showing the flow of data in a first embodiment of the invention.

FIG. 10 is a sequence chart showing the operation of the radio terminal that is shown in FIG. 6.

FIG. 11 is a sequence chart showing the operation of the base station that is shown in FIG. 7.

FIG. 12 is a block diagram showing the construction of a radio communication system of a second embodiment of the invention.

FIG. 13 is a block diagram showing the construction of the radio terminal 10-2 that is shown in FIG. 12.

FIG. 14 is a block diagram showing the construction of a radio communication system of a third embodiment of the invention.

FIG. 15 is a block diagram showing the construction of the radio terminal 10-3 that is shown in FIG. 14.

FIG. 16 is a block diagram showing the construction of a radio communication system of a fourth embodiment of the invention.

FIG. 17 is a block diagram showing the construction of the radio terminal 10-4 that is shown in FIG. 16.

FIG. 18 is a block diagram showing the construction of a radio communication system of a fifth embodiment of the invention.

FIG. 19 is a block diagram showing the construction of the radio terminal 10-5 that is shown in FIG. 18.

FIG. 20 is a block diagram showing the construction of a radio communication system of a sixth embodiment of the invention.

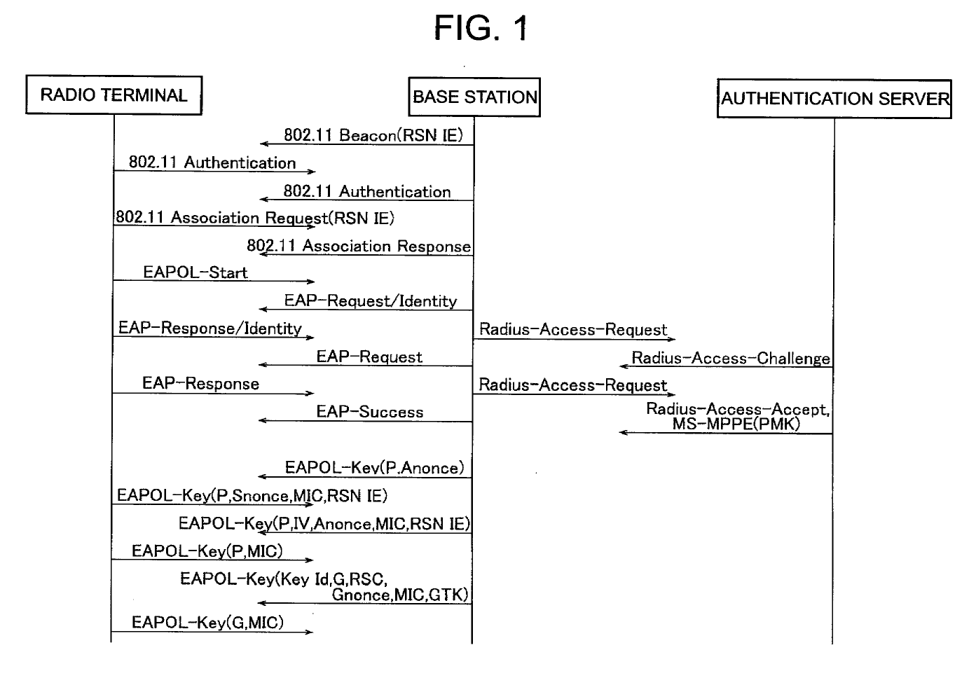

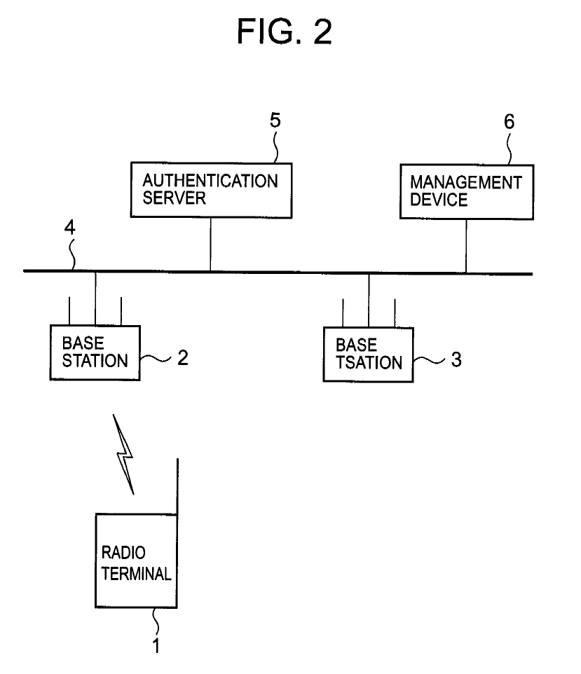

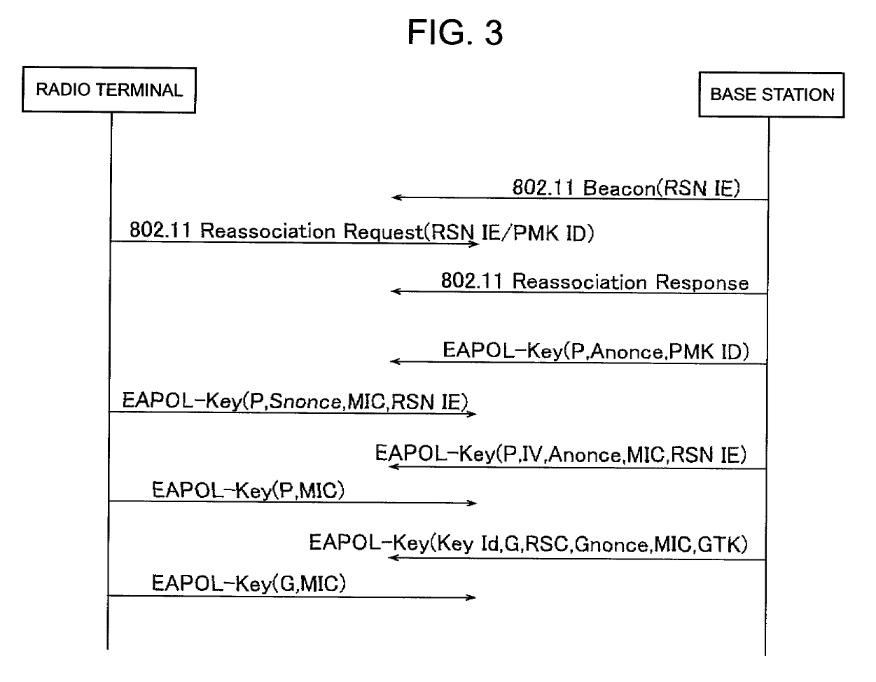

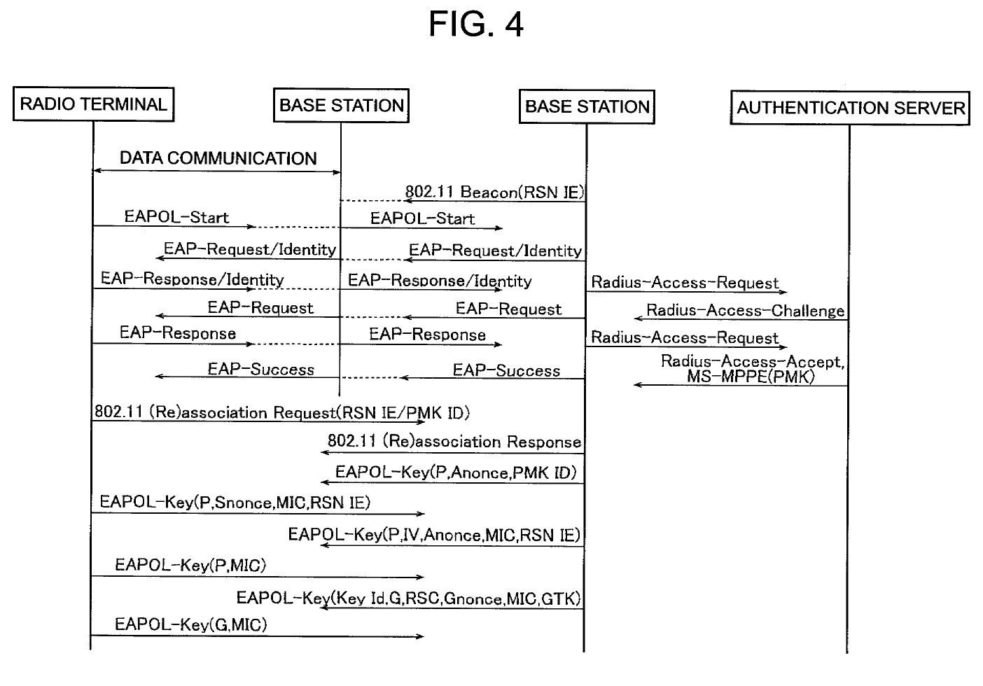

### BEST MODE FOR CARRYING OUT THE INVENTION

Some of the preferred embodiments of the invention are explained in detail below with reference to accompanying drawings.

In the following explanation, in order that the features of the present invention are made clear, detailed explanations of related well-known functions and construction are omitted.

### Embodiment 1

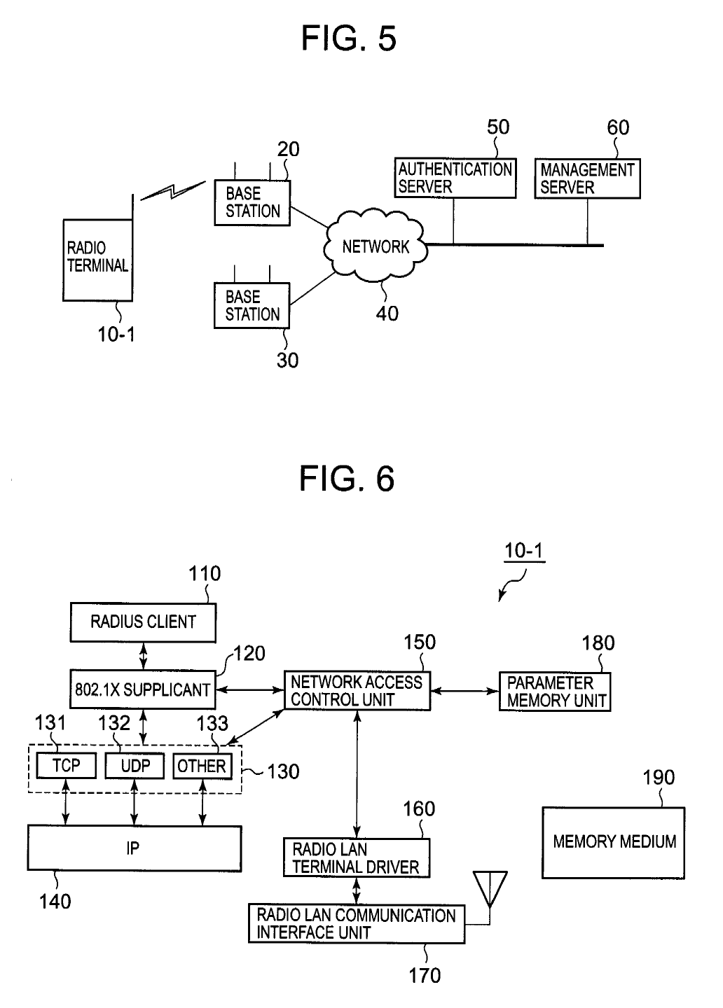

FIG. 5 is a drawing showing the construction of a radio communication system of a first embodiment of the invention.

In FIG. 5, the radio communication system of this first embodiment comprises: a network 40 that connects LAN (Local Area Network) lines or WAN (Wide Area Network) lines; a first base station 20 that is connected to a network of LAN lines or WAN lines; a second base station 30, to which connection will be moved from the first base station 20; a radio terminal 10-1 that uses radio waves as a transmission medium to connect to the network by way of the first base station 20; an authentication server 50 that is connected to the base stations 20 and 30 by the network of LAN lines or WAN lines, and that determines whether to allow or not allow connection of the radio terminal 10-1 that is attempting to move its connection by way of the second base station; and a management device 60 that is connected to the base stations 20 and 30 by the network of the LAN lines or WAN lines, and that holds information related to allowing or not allowing connection of the radio terminal 10-1 that is attempting to move its connection by way of the second base station 30.

The base station 20 has a function as a base station based on IEEE 802.11, and performs the operation of relaying data communication between the radio terminal 10-1 and a device that is connected to the network 40,

The base station 20 has a function as a base station based on IEEE 802.11i and IEEE 802.1X and as an authenticator that is specified by IEEE 802.1X, and performs connection negotiation according to a connection negotiation request from the radio terminal 10-1, and after connection negotiation is complete, starts authentication based on IEEE 802.1X of the radio terminal 10-1 for connecting to the network.

The base station 20 transfers authentication information from the radio terminal 10-1 to the authentication server 50. In other words, authentication of the radio terminal 10-1 is performed by the authentication server 50, and according to the authentication results for connecting to the network that are received from the authentication server 50, the base station 20 performs access control for each radio terminal.

After receiving notification from the authentication server 50 that authentication is successful, and receiving a PMK that is the basis for encoding future data communication between the base station 20 and radio terminal 10-1, the base station 20 notifies the radio terminal 10-1 that authentication is successful, and then performs a 4-way handshake and group key handshake for exchanging keys for encoding future data communication, and after the key for encoding data communication is set, encoded data communication becomes possible in the radio communication link.

The base station 20 has a function as a PMK cache based on IEEE 802.11i and holds the PMK for each radio terminal for which authentication was once successful, and in reconnection negotiation again with a radio terminal when there is a notification from the radio terminal 10-1 to use the PMK cache, by selecting the appropriate PMK from among the PMK that the base station 20 holds, the base station 20 omits IEEE 802.1X authentication and performs a 4-way handshake and group-key handshake with the radio terminal 10-1, and after the key for encoding data communication is set, encoded data communication becomes possible in the radio communication link.

In addition to the functions of the base station 20, the base station 30 has a function as an authentication server, authentication proxy server and authentication client, and is capable of executing tunneling processing by encapsulating the IEEE 802.1X authentication frame for pre-authentication using an authentication packet that can be transmitted over an IP network (hereafter referred to as simply IP communication). Also, the base station 30 is capable of decapsulating the encapsulated authentication packet to obtain the IEEE 802.1X authentication frame.

A typical method of performing communication with an authentication server over an IP network is to performing tunneling by encapsulating an IEEE 802.1X authentication packet that is received from the radio terminal 10-1 and that can be transmitted over an IP network, however, in addition to that, by performing tunneling by encapsulating an IP communicable authentication packet, the exchange of IEEE 802.1X authentication packets with the radio terminal 10-1 by way of an IP network is possible. As an authentication protocol for which IP communication is possible is RADIUS (Remote Authentication Dial in User Service) protocol or the like.

The radio terminal 10-1 has a function as a terminal based on IEEE 802.11, and is capable of communication with a device that is connected to the network 40 by way of the base station 20 using Internet protocol (IP).

Also, the radio terminal 10-1 has a function as a terminal based on IEEE 802.11i and IEEE 802.1X, and has a supplicant function specified by IEEE 802.1X, and before data communication becomes possible, performs connection negotiation with the base station 20 and base station 30 using a radio physical layer, after connection negotiation is complete, requests IEEE 802.1X user authentication, after user authentication is complete, performs a 4-way handshake and group-key handshake for exchanging keys for encoding future data communication, and as soon as the key for encoding data communication is set, operates as a terminal on the network.

During IEEE 802.1X authentication, a user ID and password may be necessary, and the radio terminal 10-1 may use its own user identification. Which is used depends on the authentication method that is selected when performing authentication for connecting to the network.

The radio terminal 10-1 has a function as a PMK cache based on IEEE 802.1i and holds the PMK of the base station for which authentication was successful once, and in reconnection negotiation with the base station, notifies the base station that the PMK cache will be used, and when the base station corresponds to used of a PMK cache, the radio terminal 10-1 uses the PMK that corresponds to that base station, and omitting IEEE 802.1X authentication, performs a 4-way handshake and group-key handshake with the base station, and after the key for encoding data communication is set, encoded data communication becomes possible within the radio link.

The radio terminal 10-1 has a function as an authentication client and by a performing tunneling process by encapsulating an IEEE 802.1X authentication frame for pre-authentication using an IP communicable authentication packet, can exchange IEEE 802.1X authentication packets over an IP network. Also, the radio terminal 10-1 is capable of decapsulating the encapsulated authentication packet to obtain the IEEE 802.1X authentication frame. Normally, during IEEE 802.1X authentication and pre-authentication specified by IEEE 802.11i, sending and receiving IEEE 802.1X packets is performed using MAC frames in a radio LAN.

After the radio terminal 10-1 performs connection negotiation with the base station 20, or while performing authentication during pre-authentication with the base server 30 for connecting to the network, the authentication server 50 performs authentication of the radio terminal 10-1 in the place of the base stations 20 and 30.

When user authentication is successful, the authentication server 50 notifies the base stations 20 and 30 of the PMK that is shared between the radio terminal that obtained the IEEE 802.1X authentication result and the authentication server together with the user authentication result. With the base stations 20 and 30, the authentication server 50 performs communication related to authentication and the PMK that is used for encoded data communication with the radio terminal 10-1, and with the management device 60 performs communication related to authentication of user information. Through the authentication method for connecting to the network, the authentication server 50 performs user authentication by verifying identification obtained from the radio terminal 10-1.

The management device 60 manages the account and password of the user that uses radio terminal 10-1. This function may also be included in the authentication server 50.

FIG. 6 is a block diagram showing the construction of the radio terminal 10-1 shown in FIG. 5.

In FIG. 6, the radio terminal 10-1 comprises: a RADIUS client 110, a 802.1X supplicant 120, a protocol processing unit 130, an IP protocol processing unit 140, a network access control unit 150, a radio LAN terminal driver 160, a radio LAN communication interface unit 170, a parameter memory unit 180, and a memory medium 190.

The components operate as described below.

The RADIUS client 110 encapsulates an IEEE 802.1X authentication packet for pre-authentication that is received from the 802.1X supplicant 120 and that is beyond the IP sub network into a RADIUS packet, and gives it to the 802.1X supplicant 120. Also, the RADIUS client 110 decapsulates the IEEE 802.1X authentication packet for pre-authentication that is encapsulated into a RADIUS packet and that is received from the 802.1X supplicant 120, and gives the result to the 802.1X supplicant 120.

The RADIUS client 110 can be a client that uses any other authentication protocol that is capable of IP communication.

The 802.1X supplicant 120 sends an IEEE 802.1X packet to an 802.1X authenticator, and receives an IEEE 802.1X packet from an 802.1X authenticator by way of a network access processing unit.

The 802.1X supplicant 120 has a function of performing authentication processing that is necessary for IEEE 802.1X authentication. The 802.1X supplicant 120 also has a PMK cache function specified by IEEE 802.11i, and comprises a function of storing PMK in the cache when authentication is once successfully completed. It is possible to hold a plurality of PMK at the same time, and to suitably separate the usage for each base station connected to. Moreover, in addition to pre-authentication specified by IEEE 802.11i, the 802.1X supplicant 120 comprises an IEEE 802.1X authentication function for pre-authentication that sends and receives encapsulated RADIUS packets. The 802.1X supplicant receives information necessary for authentication and requests such as an authentication start request or interrupt request from the network access control unit 150.

The protocol processing unit 130 suitably processes data received from the IP protocol processing unit 140, and transfers processed data to applications as necessary. Also, the protocol processing unit 130 suitably processes data received from applications and transfers that data to the IP protocol processing unit 140 for transmission.

The protocol processing unit 130 comprises a TCP processing unit 131, a UDP processing unit 132, and other protocol processing unit 133, and each of these processing units perform processing for a specified protocol. For example, packets for the authentication protocol that are exchanged in UDP/IP protocol are suitably processed by the UDP processing unit 132.

The IP protocol processing unit 140 suitably processes IEEE 902.3 protocol frames that are received from the radio LAN terminal driver 160, and transfers them to the protocol processing unit 130 as necessary. Also, The IP protocol processing unit 140 processes frames received from the protocol processing unit 130 for IEEE 802.3 protocol, and transfers them to the radio LAN terminal driver 160 for transmission.

The network access control unit 150 performs control related to network connection such as the connection destination and connection timing. The network access control unit 150 performs radio LAN connection negotiation control for the radio LAN terminal driver 160, performs controls such as for starting authentication for the 802.1X supplicant, and performs control related to the communication address and the like for the protocol processing unit 130 and IP protocol processing unit 140. Moreover, the network access control unit 150 sends instructions and provides information necessary for network connection. The information necessary for network connection is obtained from the parameter memory unit 180.

The radio LAN terminal driver 160 performs MAC processing for realizing the function as an IEEE 802.11 terminal. In other words, the radio LAN terminal driver 160 generates and analyzes IEEE 802.11 packets for performing connection negotiation processing with a base station. Also, the radio LAN terminal driver 160 converts IEEE 802.11 packets received from the radio LAN communication interface unit 170 to IEEE 802.3 protocol such as TCP/IP or UDP/IP, and transfers the result to the protocol processing unit 130. On the other hand, the radio LAN terminal driver 160 encapsulates IEEE 802.3 protocol frames that are received from the protocol processing unit 130 to IEEE 802.11 packets, and transmits them by way of the radio LAN communication interface unit 170.

The radio LAN terminal driver 160 transfers IEEE 802.1X packets that are received from the radio LAN communication interface unit 170 to the 802.1X supplicant 120, and transmits IEEE 802.1X packets that are received from the 802.1X supplicant and for which transmission is requested by way of the radio LAN communication interface unit 170.

The radio LAN communication interface unit 170 performs processing for transmitting data received from the radio LAN terminal driver 160 by radio waves.

Also, the radio LAN communication interface unit 170 performs processing of transferring received data to the radio LAN terminal driver 160. The radio LAN communication interface unit 170 is mainly used when communicating with the base stations 20 and 30.

The parameter memory unit 180 holds information that is necessary for network connection. For example, it holds ESSID and security setting information (user information for IEEE 802.1X authentication, the authentication method such as EAP-TLS, EAP-TTLS, PEAP, EAP-SIM and the like, the encoding method such as TKIP, AES or the like) that corresponds to ESSID for identifying the base station to be connected to.

Also, the parameter memory unit 180 holds a correlation table showing the correspondence between the ESSID or BSSID of the base station and the IP address. The values held by the parameter memory unit 180 are used by the network access control unit 150.

When the radio terminal 10-1 is a computer that includes a CPU (central processing unit) (not shown in the figure) and RAM (read only memory), the CPU performs the processing of each of the aforementioned parts by executing a program stored on the memory medium 190.

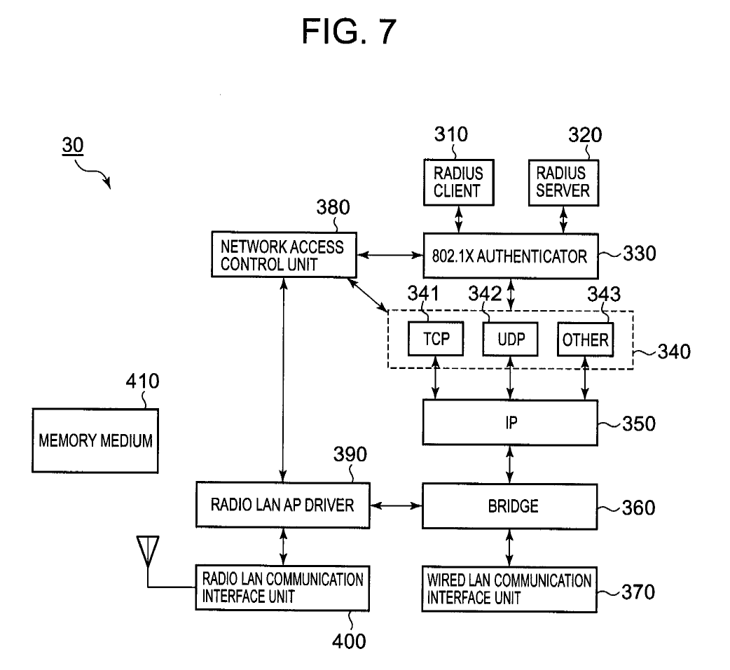

FIG. 7 is a block diagram showing the construction of the base station 30 shown in FIG. 5.

In FIG. 7, the base station 30 comprises: a RADIUS client unit 310, RADIUS server unit 320, a 802.1X authenticator 330, a protocol processing unit 340, an IP protocol processing unit 350, a bridge unit 360, a wired LAN communication interface unit 370, a network access control unit 380, a radio LAN AP driver 390, a radio LAN communication interface unit 400, and a memory medium 410.

The operation of these components is explained below.

The RADIUS client unit 310 is used for transferring IEEE 802.1X authentication to the authentication server 50 during IEEE 802.1X authentication with the radio terminal 10-1.

The RADIUS client unit 310 encapsulates IEEE 802.1X packets that are received from the 802.1X authenticator 330 into RADIUS packets, and transfers them to the 802.1X authenticator. Also, the RADIUS client unit 310 decapsulates IEEE 802.1X packets that are received from the 802.1X authenticator 330 and that are encapsulated into RADIUS packets, and transfers them to the 802.1X authenticator 330. The RADIUS client 310 could also be a client function that uses other authentication protocol and that is capable of IP communication.

The RADIUS server unit 320 encapsulates IEEE 802.1X packets for pre-authentication that are received from the 802.1X authenticator 330 and that are beyond the IP sub network to RADIUS packets, and transfers them to the 802.1X authenticator 330. Also, the RADIUS server unit 320 decapsulates 802.1X packets for pre-authentication that were received from the 802.1X authenticator and encapsulated into RADIUS packets, and transfers them to the 802.1X authenticator 330.

The RADIUS server unit 320 could also be a server function that uses other authentication protocol and that is capable of IP communication.

The 802.1X authenticator 330 sends IEEE 802.1X packets to the 802.1X supplicant, and receives IEEE 802.1X packets from the 802.1X supplicant by way of the network access processing unit.

The 802.1X authenticator 330 has a function of performing authentication processing necessary for IEEE 802.1X authentication. The 802.1X authenticator 330 has a function as an IEEE 802.1X specified PMK cache, and comprises a function of storing the PMK after authentication with the radio terminal 10-1 is successfully completed once in the PMK cache. Moreover, in addition to IEEE 802.1X specified pre-authentication, the 802.1X authenticator 330 comprises an IEEE 802.1X authentication function for sending and receiving packets encapsulated to RADIUS packets.

The protocol processing unit 340 suitably processes data that are received from the IP protocol processing unit 350, and transfers the processed data as necessary to applications. Also, the protocol processing unit 340 suitably processes data that are received from an application, and transfers the result to the IP protocol processing unit 350 for transmission.

The protocol processing unit 340 comprises a TCP processing unit 341, a UDP processing unit 342 and other processing unit 343, and each of the processing units perform processing for a specified protocol. For example, the UDP processing unit 342 suitably processes packets for an authentication protocol exchanged by UDP/IP.

The IP protocol processing unit 350 suitably processes IEEE 802.3 protocol frames that are received from the bridge unit 360, and transfers them as necessary to the protocol processing unit 340. Also, the IP protocol processing unit 350 processes frames received from the protocol processing unit 340 into IEEE 802.3 protocol, and transfers the results to the bridge unit 360 for transmission.

The bridge unit 360 performs processing for separating transmission data received from the IP protocol processing unit 350 to the wired LAN communication interface unit 37 or radio LAN AP driver 390 according to the transmission destination.

When the base station 30 transfers data that are received from the wired LAN communication interface unit 370 without processing the data itself, it transfers the data to the radio LAN AP driver 390, or when the base station transfers data that are received from the radio LAN AP driver 390 without processing the data itself, it transfers the data to the wired LAN communication interface unit 370. Data that are processed by the base station 30 itself are transferred to the IP protocol processing unit 350.

The wired LAN communication interface unit 370 is connected to the network 40, and performs processing for transmitting data received from the bridge unit 360 to the network.

Also, the wired LAN communication interface unit 370 performs processing to transfer data received from the network to the bridge section 360.

The wired LAN communication interface unit 370 is used when sending or receiving IEEE 802.1X packets as RADIUS packets between the ratio terminal 10-1 and the authentication server during IEEE 802.1X authentication, and when performing communication with a terminal that is connected to the wired side.

The network access control unit 380 performs control related to connection of the radio terminal 10-1 that is attempting to connect or is connected to the network access control unit 380 itself or to the base station 30. The network access control unit 380 performs radio LAN connection negotiation control for the radio LAN AP driver, performs control such as control for starting authentication for the 802.1X authenticator 330, and performs control related to communication destination addresses or data routing for the protocol processing unit 340, IP protocol processing unit 350 and bridge unit 360. Also, the network access control unit 380 sends instructions related to or provides information necessary for network connection requests from the radio terminal 10-1.

The radio LAN AP driver 390 performs MAC processing for realizing a function as an IEEE 802.11 base station. In other words, the radio LAN AP driver 390 generates and analyzes IEEE 802.11 packets for performing connection negotiation processing with the radio terminal 10-1. Also, the radio LAN AP driver 390 converts IEEE 802.11 packets that are received from the radio LAN communication interface unit 400 to IEEE 802.3 protocol such as TCP/IP or UDP/IP, and transfers them to the bridge unit 360. On the other hand, the radio LAN AP driver 390 encapsulates IEEE 802.3 protocol frames that are received from the bridge unit 360 into IEEE 802.11 packets by way of the radio LAN communication interface unit 400.

The radio LAN AP driver 390 transfers IEEE 802.1X packets received from the radio LAN communication interface unit 400 to the 802.1X authenticator 330, and transmits IEEE 802.1X packets, for which a transmission request has been received from the 802.1X authenticator, by way of the radio LAN communication interface unit 400.

The radio LAN communication interface unit 400 performs processing for transmitting data received from the radio LAN AP driver 390 by radio waves. Also, the radio LAN communication interface unit 400 performs processing for transferring received data to the radio LAN AP driver 390. The radio LAN communication interface unit 400 is mainly used during communication with the radio terminal 10-1.

When the base station 30 is a computer that includes a CPU (central processing unit) (not shown in the figure) and RAM (read only memory), the CPU can perform the processing of each of the parts described above by executing a program that is stored in the memory unit 410.

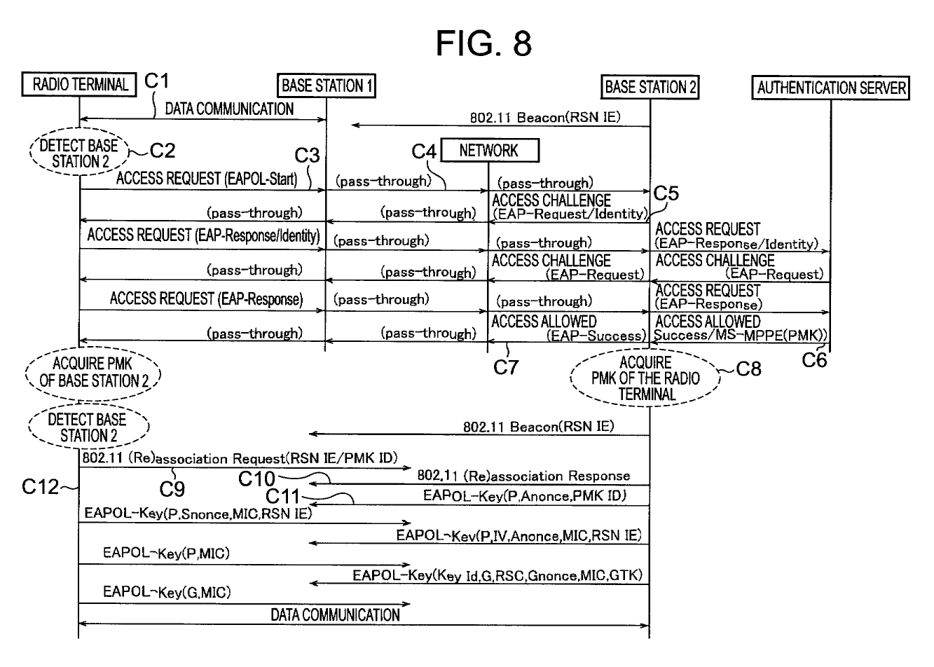

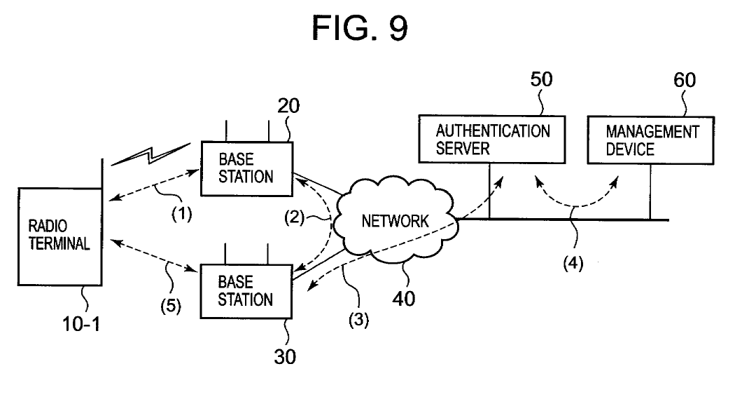

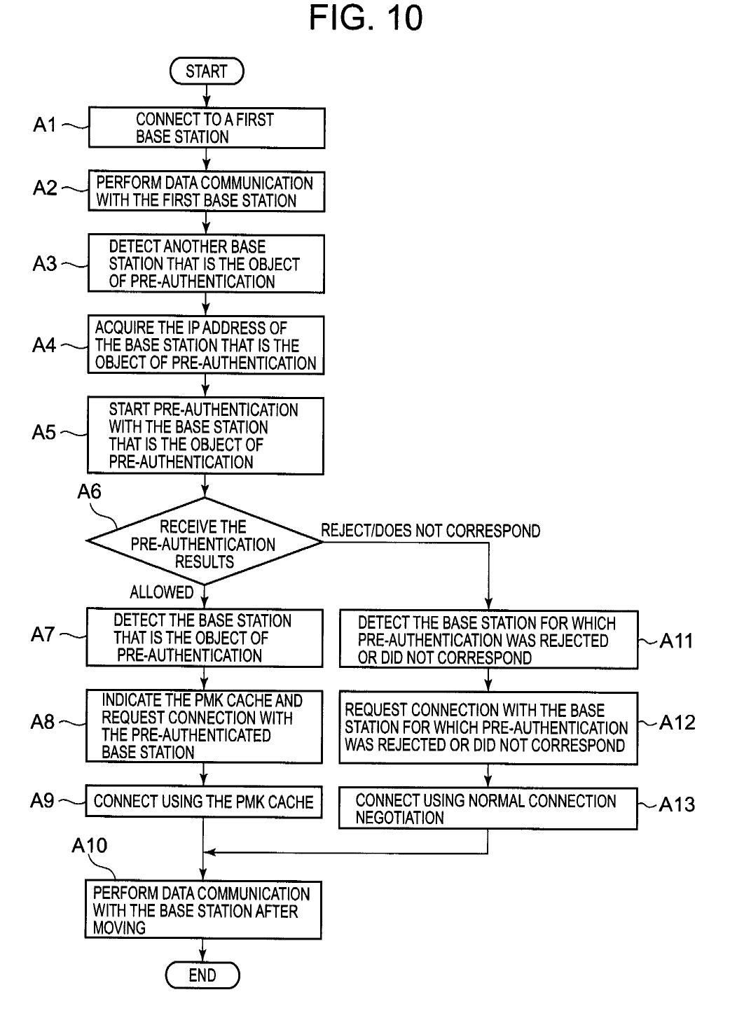

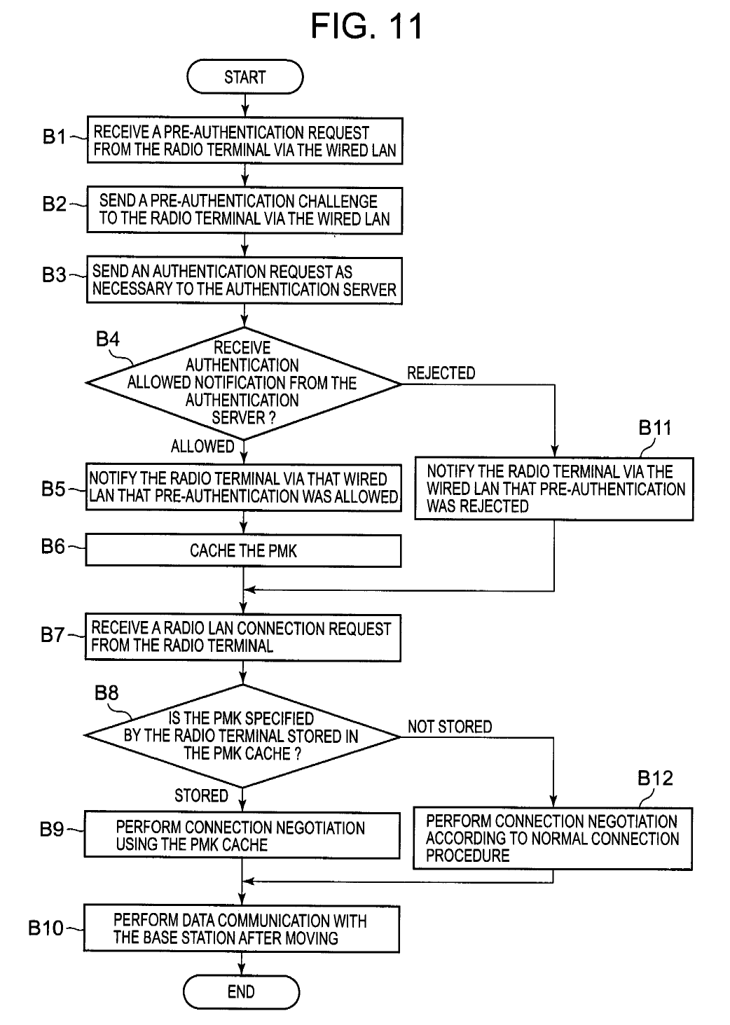

Next, the overall operation of this embodiment will be explained in detail with reference to FIG. 8 that is a sequence chart showing the flow of overall operation of a radio communication system, FIG. 9 that is a network diagram showing the flow of data between devices of a radio communication system, FIG. 10 that is a flowchart showing the operation of the radio terminal 10-1, FIG. 11 that is a flowchart showing the operation of the base station 30 that is the target of pre-authentication, and FIGS. 5 to 7.

The processing shown in FIG. 10 is realized by the CPU of the computer of the radio terminal 10-1 transferring a program that is stored on the memory medium 190 to RAM and executing that program; and the processing shown in FIG. 11 is realized by the CPU of the computer of the base station 30 transferring a program that is stored on the memory medium 410 to RAM and executing that program.

First, in order for the radio terminal 10-1 to connect to the network and perform communication by way of the base station 20, negotiation is performed between the radio terminal 10-1 and the base station 20, and data communication becomes possible (see C1 in FIG. 8, (1) in FIG. 9, and step A1 and step A2 in FIG. 10).

The negotiation between the radio terminal 10-1 and the base station 20 may be only IEEE 802.11 connection negotiation with encoded communication by a WEP key, or connection may be allowed according to the result of IEEE 8021X authentication with encoded communication by a dynamically set WEP key, or connection may be by security enhanced WPA (Wi-Fi Protected Access).

Next, by acquiring notification information that is sent from another base station 30 that is different than the currently connected base station 20, the radio terminal 10-1 detects the existence of another base station 30 that is the object of pre-authentication (see C2 in FIG. 8, (5) in FIG. 9, and step A3 in FIG. 10). In the radio terminal 10-1, the aforementioned notification information that was received from the radio LAN communication interface unit 170 is transferred to the network access control unit 150 by way of the radio LAN terminal driver 160. For example, the beacon or probe response that is sent out by the base station 30 contains ESSID or BSSID and a base station name that identifies the network of that base station 30.

The radio terminal 10-1 sets to perform the pre-authentication of this invention with the base station 30 that is the object of pre-authentication by way of the currently connected base station 20, and then based on the information (ESSID, BSSID, etc.) acquired from information that is sent by the base station 30 that is the object of pre-authentication, the network access control unit 150 shown in FIG. 6 acquires the IP address of the base station 30 that is the object of pre-authentication from a correlation table of ESSID or BSSID and IP addresses that is stored in the parameter memory unit 180 (see step A4 in FIG. 10). For example, an IP address that corresponds to an ESSID, or an IP address that corresponds to a BSSID is stored in the parameter memory unit 180, and the network access control unit 150 acquires the IP address that corresponds to the BSSID of the base station that is the object of pre-authentication.

After acquiring the IP address of the base station 30 that is the object of pre-authentication, the radio terminal 10-1 starts pre-authentication with the base station 30 that is the object of pre-authentication (see C3 in FIG. 8, (5) in FIG. 10, and step A5 in FIG. 10).

In the radio terminal 10-1, an instruction is sent from the network access control unit 150 to the 802.1X supplicant 120 to start pre-authentication with the base station 30.

The 802.1X supplicant 120 generates an IEEE 802.1X frame for starting pre-authentication, which then passes through the RADIUS client unit 110 that generates RADIUS packets, and transmits the packets to the currently connected base station 20 with the acquired IP address destination by way of the protocol processing unit 130, IP protocol processing unit 140, the radio LAN terminal driver 160 and radio LAN communication interface unit 170. After that, in the radio terminal 10-1, IEEE 802.1X packets for pre-authentication are encapsulated into RADIUS packets and transmitted in the flow described above.

Also, RADIUS packets that are received in response to the transmitted RADIUS packets reach the 802.1X supplicant 120 according to flow that is opposite that described above. For example, in the radio LAN link, the MAC address of the currently connected base station is specified in the field indicating the BSSID of the base station, and the IP address of the base station that is the object of pre-authentication is specified in the destination IP address in the IP header, and the RADIUS packets are included in the packet.

The base station 20 that received the RADIUS packets and to which the radio terminal 10-1 is currently connected suitably performs transfer processing to that the packets are transferred to the IP address (see C4 in FIG. 8, (2) in FIG. 9 and step B1 in FIG. 11).

The base station 30 that is the object of pre-authentication and that received the RADIUS packets by way of the network 40 encapsulates an EAP-Request/Identity packet, which is an IEEE 802.1X packet for requesting the identifier of the radio terminal 10-1, to a RADIUS packet, and similar to the radio terminal, transmits the packet to the radio terminal 10-1 over the network 40 by way of the base station 20 to which the radio terminal 10-1 is currently connected (see C5 in FIG. 8, (2) and (1) in FIG. 9, and step B2 in FIG. 11).

In the base station 30 that is the object of pre-authentication, the RADIUS packet that is received from the wired LAN communication interface unit 370 transfers the packet to the 802.1 authenticator 330 by way of the bridge unit 360, IP protocol processing unit 350 and protocol processing unit 340, and in the RADIUS server unit 320, the RADIUS packet is decapsulated and the IEEE 802.1X frame for pre-authentication reaches the 802.1X authenticator 330.

The 802.1X authenticator 330 first transmits the EAP-Request/Identity packet, which is an IEEE 802.1X frame for requesting the identifier of the radio terminal 10-1 (see FIG. 8, and step B2 in FIG. 11).

During transmission, opposite from reception, the RADIUS server unit 320 encapsulates the frame to a RADIUS packet, and the RADIUS packet is sent to the radio terminal 10-1, which is the transmission source, by way of the protocol processing unit 40, IP protocol processing unit 350, bridge unit 360, and wired LAN communication interface unit 370.

After that, in the base station 30 that is the object of pre-authentication, the IEEE 802.1X frames for pre-authentication are transmitted and received according to the flow described above.

The exchange of IEEE 802.1X frames for pre-authentication that are encapsulated into RADIUS packets that are exchanged between the radio terminal 10-1 and base station 30 that is the object of pre-authentication is performed in the same was as normal exchange of frames in IEEE 802.1X authentication.

Also, the exchange of IEEE 802.1X authentication, even when the authentication method used differs, such as EAP-TLS, EAP-TTLS, PEAP and EAP-AKA, is performed in the same way as the normal exchange of IEEE 802.1X authentication.

In the base station 30 that is the object of pre-authentication, in order to perform authentication of the radio terminal 10-1 by the authentication server 50 instead of the base station performing it itself, the 802.1X authenticator 330 exchanges the IEEE 802.1X frame that is received by the 802.1X authenticator 330 as a RADIUS packet with the authentication server 50 by way of the RADIUS client unit 310 in order to exchange the frame with the authentication server 50.

The authentication server 50 performs authentication of the radio terminal 10-1 in the place of the base station 30. According to a user authentication request from the base station, the authentication server 50 performs authentication of the radio terminal 10-1 using user information that it has itself or by communicating with the management device 60, then notifies the base station 30 of the user authentication results.

When user authentication is successful, the authentication server 50 notifies the base station 30 of the PMK that is shared between just the radio terminal 10-1 that obtained the IEEE 802.1X authentication result and the authentication server 50 together with the user authentication result (see C6 in FIG. 8, and step B4 in FIG. 11).

After receiving the authentication results for the radio terminal 10-1 from the authentication server 50, the base station 30 that is the object of pre-authentication transmits IEEE 802.1X authentication result notification for pre-authentication that has been encapsulated in a RADIUS packet similar as has been done previously to the radio terminal 10-1 again similarly by way of the network 40 and base station 20 (see C7 in FIG. 8, step A6 in FIG. 10 and step B5 in FIG. 11).

When IEEE 802.1X authentication for pre-authentication is successful, the IEEE 802.1X authentication successful notification and the PMK are divided by the RADIUS client unit 310 in the base station 30 that received the PMK for the radio terminal 10-1 for which authentication was successful, and transferred to the 802.1X authenticator 330. The PMK is not transferred to the radio terminal 10-1, but is stored in its own PMK cache (see C8 in FIG. 8, step A6 in FIG. 10, and step B6 in FIG. 11).

The radio terminal 10-1 that received a pre-authentication successful notification from the base station 30 that is the object of pre-authentication by way of the currently connected base station 20 stores the PMK acquired in the IEEE 802.1X authentication process for pre-authentication in its own PMK cache, and stores the correlation between the information (ESSID or BSSID, etc.) sent from the base station 30 that is the object of pre-authentication and the cached PMK (see C8 in FIG. 8, and step A6 in FIG. 10).

The radio terminal 10-1 notifies the base station 30 of the radio terminal's 10-1 own MC address that is necessary for using the PMK cache that is specified by IEEE 802.11i by including it in a RADIUS packet for encapsulating the IEEE 802.1X authentication frame.

The radio terminal 10-1 detects the existence of the base station 30 for which pre-authentication was performed from information that is sent from the base station 30, and after setting to move from the currently connected base station 20 to the base station 30 for which pre-authentication was performed, the radio terminal 10-1 starts connection negotiation with the base station 30 for which pre-authentication was performed (see C9 in FIG. 8, steps A7 and A8 in FIG. 10 and step B7 in FIG. 11).

The connection negotiation between the radio terminal 10-1 and the base station 30 for which pre-authentication was performed can use an IEEE 802.11i specified PMK cache. In other words, in an IEEE 802.11 (re-) association request to the base station 30, the radio terminal 10-1 specifies an ID for identifying the PMK that is cached in pre-authentication together with an RSN IE (Robust Security Network Information Element). The radio terminal is able to hold a plurality of PMK at the same time, so the radio terminal 10-1 references base station information (ESSID or BSSID) that is correlated with the PMK and stored when storing a PMK in the PMK cache, and thus is capable of selecting a suitable PMK. Also, the IEEE 802.11 (re-) association request can contain a plurality of PMK ID at the same time. In that case, as will be described later, key exchange is performed by using the PMK ID that is selected by the base station 30.

The base station 30 that is performing connection negotiation with the radio terminal 10-1 receives the IEEE 802.11 (re-) association request that includes the RSN IE/PMK ID, and returns an IEEE 802.11 (re-) association response to the radio terminal 10-1 (see C10 in FIG. 8).

The base station 30 has used the MCA address, which was notified from the radio terminal 10-1 when performing IEEE 802.1X authentication with the radio terminal 10-1 using RADIUS packets, and the PMK, which was acquired by way of pre-authentication that was performed with the radio terminal 10-1 and stored in a PMK cache by the radio terminal itself, to generate PMK ID beforehand for identifying the radio terminal 10-1. This PMK ID is used for identifying which PMK to use when the radio terminal 10-1 performs connection using the PMK cache.

The base station 30 compares the IDs for identifying PMK that are stored in the PMK cache by itself with the PMK ID that is received in the IEEE 802.11 (re-) association request from the radio terminal 10-1, and when there is a match, uses the PMK that is identified by that PMK ID and exchanges keys (see steps B8 and B9 in FIG. 11).

When exchanging keys, the base station 30 includes the PMK ID in the EAPOL-Key frame, which is the first message of a 4-way handshake, and sends them to the radio terminal 10-1 (see C11 in FIG. 8).

The radio terminal 10-1 receives the EAPOL-Key frame that includes the PMK ID and confirms that the PMK ID matches the PMK ID that was specified in the IEEE 802.11 (re-) association request, or confirms that the PMK ID is a PMK ID that was selected by the base station from a plurality of specified PMK ID (see C12 in FIG. 8).

After that, by continuing in performing normal 4-way handshake processing and group-key handshake processing, a key is finally set for encoded communication, and encoded data communication becomes possible.

At this point, it is also possible to perform the pre-authentication of the present invention with yet another base station, and in this case as well, in connecting with the other base station, radio LAN connection using a PMK cache is possible.

In step A6 shown in FIG. 10, when notification is received that pre-authentication failed, the radio terminal 10-1 performs normal IEEE 802.11 connection negotiation, IEEE 802.1X authentication and key exchange when performing radio LAN connection with the base station for which pre-authentication failed, and after that, encoded data communication is performed (see steps A11, A12, A13 and A10 in FIG. 10).

The radio terminal 10-1 and base terminal 30 that cache PMK by pre-authentication, can have a holding period for the cached PMK. The PMK could be deleted if the PMK is not used within the holding period. In other words, after the holding period has elapsed and radio LAN connection negotiation using the PMK cache is attempted, since the PMK is already deleted, the base station 30 may request normal connection negotiation, or since the PMK is already deleted, the radio terminal 10-1 may not be able to perform connection using the PMK cache.

Instead of including an EAPOL-Start frame, the access request shown in FIG. 8 may be a frame from which the base station 30 can determine the start of pre-authentication, for example, can be an access request frame in which contents indicating the start of pre-authentication are included in the access request.

In the explanation of this first embodiment, there was only one authentication server, however, construction can be such that authentication is performed by using a different authentication server for each base station.

Next, the effect of the first embodiment is explained.

In the first embodiment, both the radio terminal and the base station that is the object of pre-authentication are constructed so that communication is possible between them over an IP network by encapsulating an IEEE 802.1X authentication frame into an IP communicable authentication packet, so in IEEE 802.11i specified pre-authentication, instead of just being able to perform pre-authentication in an IP sub network, as long as communication between the radio terminal and base station that is the object of pre-authentication is possible over an IP network, it is possible to perform pre-authentication. Therefore, the amount of radio LAN connection negotiation can be reduced, and it is possible to shorten the period of time that radio LAN communication is interrupted.

Also, in this first embodiment, construction is such that the radio terminal further comprises a parameter memory unit 180 that is capable of storing beforehand the correspondence of ID addresses for the base stations, so the IP address of the base station 30 that is the object of pre-authentication can be identified.

### Variation of Embodiment 1

Next, an example of a variation of the first embodiment is explained in detail with reference to FIG. 7.

Referring to FIG. 7, except that the operation of the 802.1X authenticator 330 and RADIUS server unit 320 is partially different than in the first embodiment, this example of a variation of the first embodiment has the same construction as the first embodiment.

The 802.1X authenticator 330 in the base station 30 differs from that of the first embodiment in that the processing operation of the RADIUS packet for pre-authentication that is exchanged with the 802.1X of the radio terminal 10-1 is partially different.

In the first embodiment, the 802.1X authenticator 330 performed processing of transferring the RADIUS packet for pre-authentication to the RADIUS server unit 320 right after receiving it, receiving a decapsulated RADIUS packet as an IEEE 802.1X packet, and changing the IEEE 802.1X packet to a RADIUS packet in the RADIUS client unit 310 in order to transfer the received IEEE 802.1X packet to the authentication server 50, and on the other hand, performed processing of changing the response RADIUS packet from the authentication server 50 to an IEEE 802.1X packet in the RADIUS client unit 310, and transferring the IEEE 802.1X packet to the RADIUS server unit 320 in order to send it to the 802.1X supplicant 120 of the radio terminal 10-1, however, in this variation of the first embodiment, after the 802.1X authenticator receives a RADIUS packet for pre-authentication and transfers it to the RADIUS server unit 320, the RADIUS server unit 320 performs operation as a RADIUS proxy, or in other words, after performing the necessary processing as proxy operation, returns the RADIUS packet as is to the 802.1X authenticator 330. The 802.1X authenticator 330 transfers the aforementioned RADIUS packet to the authentication server 50. The RADIUS packet that is returned from the authentication server 50 is sent as is to the radio terminal 10-1 after passing through the RADIUS server unit 320 that operates as a RADIUS proxy.

In the first embodiment, the RADIUS server unit 320 performed the encapsulation of the RADIUS packet for pre-authentication, and the opposite process, however, in this variation of the first embodiment, the operation largely differs in that the RADIUS server unit 320 operates as a RADIUS proxy server.

After performing the process of proxy operation on the RADIUS packet received from the 802.1X authenticator 330, the RADIUS server unit 320 transfers the RADIUS packet as is to the 802.1X authenticator 330.

When the RADIUS server unit 320 finally receives a packet from the authentication server 50 notifying that authentication was successful, the RADIUS server unit 320 separates the PMK information, which is attached to the packet that notifies that authentication was successful, from the packet that notifies that authentication was successful and without transferring the PMK information to the radio terminal 10-1, transfers the packet that notifies that authentication was successful to the radio terminal 10-1, and separately transfers the PMK to the 802.1X authenticator 330. The RADIUS server unit 320 can also have a server function that makes possible other IP communicable authentication protocol.

In this variation of the first embodiment, the points that differ from the first embodiment are related to the operation of the 802.1X authenticator 330 and RADIUS server unit 320 of the base station 30. Below, only these different points will be explained.

The construction and operation of the radio terminal 10-1 are the same, and first performs suitable connection negotiation with and connects to a first base station 20, and when by some method detects a base station 30 that is the object of pre-authentication, sends a packet to the base station requesting to start the pre-authentication of this invention.

The base station 30 receives the packet requesting to start pre-authentication, and sends a packet to the radio terminal requesting an ID.

In the base station 30, by way of the wired LAN communication interface unit 370, bridge unit 360, IP protocol processing unit 350 and protocol processing unit 350, the 802.1X authenticator receives the packet encapsulated as a RADIUS packet requesting to start pre-authentication. This RADIUS packet is decapsulated by the RADIUS server unit 320, and the 802.1X authenticator 330 responds to the pre-authentication start request from the radio terminal 10-1 with a packet requesting an ID.

The packet encapsulated as a RADIUS packet requesting to start pre-authentication may be a packet that can be determined by the 802.1X authenticator as the start of pre-authentication, or can be a RADIUS packet, in which an attribute value included in the RADIUS packet indicates a request to start pre-authentication.

After receiving the pre-authentication packet encapsulated as a RADIUS packet requesting an ID, the radio terminal 10-1 sends a response to the base station using a pre-authentication packet encapsulated as a RADIUS packet in which the ID of the radio terminal 10-1 is inserted.

After the base station 30 receives the pre-authentication packet encapsulated as a RADIUS packet in which the ID of the radio terminal 10-1 is inserted, it attaches an attribute indicating that the packet is a RADIUS proxy packet, then performs processing for secure communication with the authentication server 50 and transfers the packet to the authentication server 50. Similarly, in this case the base station 30 removes the attribute indicating that the packet is a RADIUS proxy packet from the RADIUS proxy packet returned from the authentication server 50, and then performs processing for secure communication with the radio terminal 10-1 and transfers the packet to the radio terminal 10-1.

After that, depending on the authentication method, the contents exchanged among the radio terminal 10-1, base station 30 and authentication server 50 differ, however pre-authentication that is the same as IEEE 802.1X authentication is performed.

Finally, the base station 30 receives a RADIUS packet with an attribute that includes the PMK from the authentication server 50 indicating that authentication was successful, and removes the attribute that includes the PMK from the RADIUS packet and transfers the packet to the radio terminal 10-1. The base station 30 stores the PMK itself in the PMK cache, so that connection using the PMK cache is possible.

After that, when the radio terminal 10-1 performs radio LAN connection negotiation with the base station 30, by using the cached PMK, connection becomes possible using the PMK cache.

Next, the effect of this variation of the first embodiment is explained.

In this variation of the first embodiment, construction is such that in the base station 30, it is not necessary to regenerate a RADIUS packet between the base station 30 and authentication server 50 for a RADIUS packet between the radio terminal 10-1 and the base station 30, so the amount of RADIUS packet processing by the base station can be reduced.

### Embodiment 2

Next, a second embodiment of the invention will be explained in detail with reference to the supplied drawings.

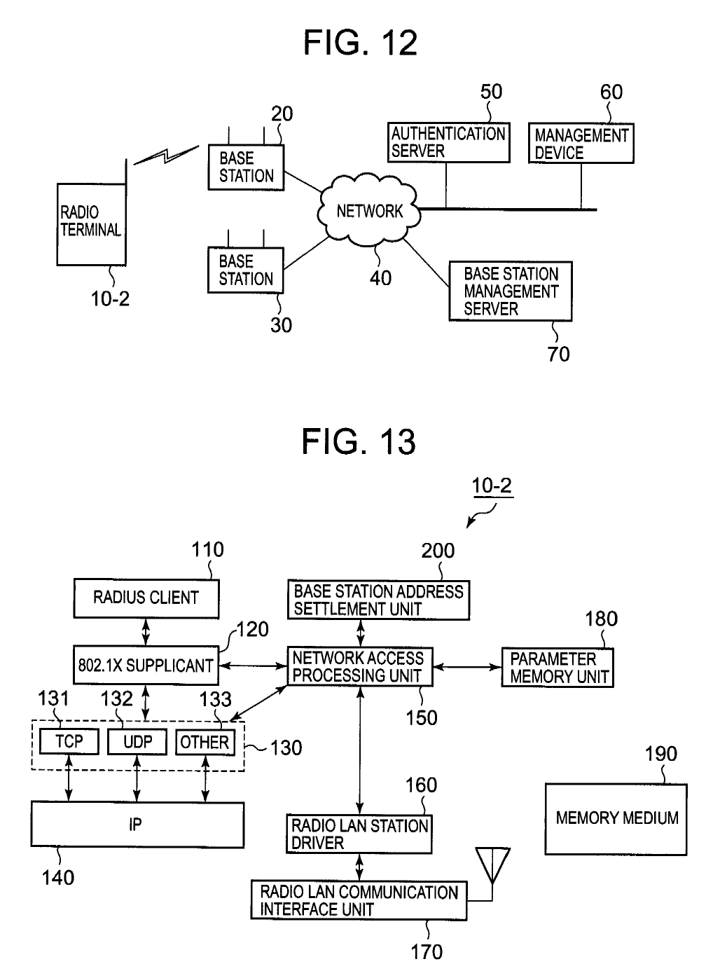

FIG. 12 is a drawing showing the construction of a radio communication system of a second embodiment.

In FIG. 12, the radio communication system differs from that of the first embodiment and variation thereof described above in that there is a base station management server 70.

The base station management server 70 manages IP addresses that correspond with the BSSIE or ESSID of the base station, the base station name and the like. When the base station management server 70 receives an IP address settlement request from a radio terminal, it returns an IP address from its own correlation table between IP addresses and BSSID or ESSID of the base stations, base station names and the like that correspond to the base station that is the object of the IP address settlement request.

The protocol between the base station management server 70 and the terminal that sends the IP address settlement request may be a unique protocol that resembles DNS (Dynamic Name Service) protocol, or a protocol that uses HTTP (Hyper Text Transfer Protocol) or HTTPS (Hyper Text Transfer Protocol over SSL).

In FIG. 13, the construction of the radio terminal 10-2 of this second embodiment differs in that in addition to the construction of the radio terminal 10-1 of the first embodiment and variation thereof, there is a base station address settlement unit 200.

The base station address settlement unit 200 performs communication with the base station management server 70 shown in FIG. 12, and serves the role of deciding the IP address of the base station.

When the BSSID address of a base station for which the IP address is not known is received from the network access processing unit 150, the base station address settlement unit 200 sends an inquiry to the base station management server 70 for the IP address corresponding to the BSSID address. The base station address settlement unit 200 gives the IP address obtained from the base station management server 70 to the network access processing unit 150.

Also, the base station address settlement unit 200 not only sends an inquiry for the IP address corresponding to a BSSID address, but also has a function of sending an inquiry for the IP address from the ESSID. Moreover, when it is possible to obtain the base station name of the base station from information that is sent by the base station, the base station address settlement unit 200 also has a function of making an inquiry of the IP address from the base station. The protocol used between the base station address settlement unit 200 and the base station management server 70 may be a unique protocol that resembles DNS protocol, or a protocol that uses HTTP or HTTPS.

In FIG. 13, the operation of the radio terminal 10-2 of this second embodiment, when compared with the operation of the radio terminal 10-1 of the first embodiment or variation thereof, differs a little with respect to the network access processing unit 150. In the first embodiment and variation thereof, the IP address of the base station that is the object of pre-authentication is obtained from the parameter memory unit 180, however, in this second embodiment, a request is sent to the base station address settlement unit 200 to determine the IP address from information (BSSID, ESSID, base station name or the like) that is sent by the base station, and using the IP address obtained from an inquiry made by the network base station address settlement unit 200, the network access processing unit 150 starts the pre-authentication of this invention. Also, the network access processing unit 150 can store the obtained IP address in the parameter memory unit 180.

In this second embodiment, only the method that the radio terminal 10-2 uses to obtain the IP address of the base station that is the object of pre-authentication is different, the other operation is the same as the operation of the radio terminal of the first embodiment and variation thereof described above. Also, the construction and operation of the base stations 20, 30, the authentication server 50 and management device 60 are the same as in the first embodiment and variation thereof.

The second embodiment could also be used in combination with either the first embodiment or variation thereof.

Next, the effect of the second embodiment is explained.

In the first embodiment and variation thereof, the radio terminal 10-1 had to have the IP address of the base station in advance, however in the second embodiment, construction is such that there is a base station address settlement unit 200, so it is possible to obtain the IP address of the base station dynamically. Therefore, this is no need to set the IP address of the base station in the radio terminal 10-2 beforehand.

### Embodiment 3

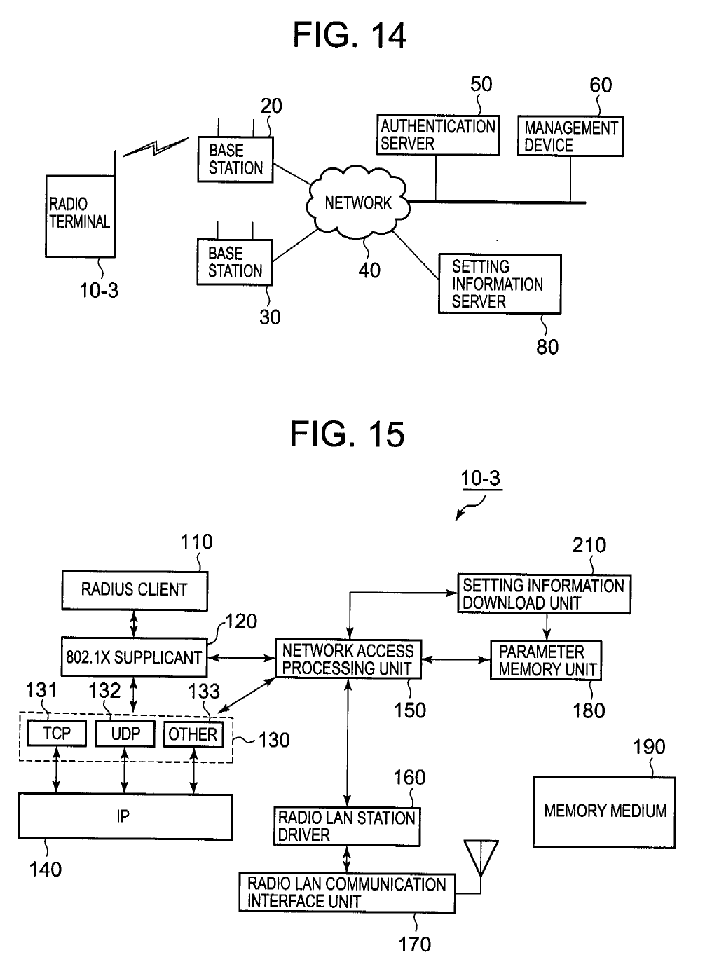

FIG. 14 is a drawing showing the construction of a radio communication system of a third embodiment of the invention.

In FIG. 14, the construction differs from the construction of the radio communication system of the first embodiment and variation thereof described above in that there is a setting information server 80.

The setting information server 80 holds a set of information that is necessary when the radio terminal is performing radio LAN connection with a base station. After receiving a setting information acquisition request from the radio terminal, the setting information server 80 returns the set of information to the radio terminal that is necessary for radio LAN connection.

The information that is necessary for radio LAN connection includes ESSID and security information that is necessary for connecting to a base station for which the ESSID is known (includes settings and pass phrases necessary for the encoding method such as WEP, TK-IP, AES, etc. from the connection method such as WPA, IEEE 802.1X authentication method, and various authentication methods), and information necessary for IP connection (such as the IP address, net mask, gateway address, DNS address or DHCP setting of the radio terminal).

Also, the settings for each base station includes whether or not the base station corresponds to the pre-authentication of the present invention, and when the base station corresponds, the settings include the IP address, which is the connection destination, for the base station. It is possible to include a plurality of sets of information necessary for radio LAN connection.

Moreover, the protocol between the setting information server 80 and the terminal that sends the setting information acquisition request may be protocol that uses HTTP (Hyper Text Transfer Protocol) or HTTPS (Hyper Text Transfer Protocol over SSL (Secure Sockets Layer)), or may be a uniquely specified protocol. The actual exchanged information is according to XML (Extensible Markup Language), and is entered such as <network><wlan><essid>ap1</essid><assoc>wpa</assoc><enc>tki p</enc><bssid>aaaaaaaaaa</bssid><ip>0.0.0.0</ip></wlan><net work>.

In FIG. 15, the construction of the radio terminal 10-3 of this third embodiment differs in that in addition to the construction of the radio terminal 10-1 of the first embodiment or variation thereof described above, there is a setting information download unit 210.

The setting information download unit 210 performs communication with the setting information server 80 shown in FIG. 14, and in the radio terminal, it serves the role of obtaining setting information that is necessary for radio LAN connection, and storing that information in the parameter memory unit. After receiving an instruction from the network access processing unit 150 to download setting information from a specified information server 80, the setting information download unit 210 sends a setting information acquisition request to the specified setting information server 80. The setting information download unit 210 stores the setting information that is obtained from the setting information server 80 and that is necessary for radio LAN connection in the parameter information memory unit 180, and then notifies the network access processing unit 150 that acquisition of setting information has finished.

It is possible to have a plurality of sets of information necessary for radio LAN connection.

Moreover, the protocol between the setting information server 80 and the terminal that sends the setting information acquisition request may be protocol that uses HTTP (Hyper Text Transfer Protocol) or HTTPS (Hyper Text Transfer Protocol over SSL (Secure Sockets Layer)), or may be a uniquely specified protocol. The actual exchanged information is according to XML (Extensible Markup Language), and is entered such as <network><wlan><essid>ap1</essid><assoc>wpa</assoc><enc>tki p</enc><bssid>aaaaaaaaaa</bssid><ip>0.0.0.0</ip></wlan><net work>.

In FIG. 15, the operation of the radio terminal 10-3 of this third embodiment compared with the operation of the radio terminal 10-1 of the first embodiment or variation thereof, differs in that the network access processing unit 150 is a little different. In the first embodiment and variation thereof, the radio LAN connection information and the information for the base station that is the object of pre-authentication, or in other words, IP address of the base station, are obtained from the parameter memory unit 180 where the information is stored in advance, however, in this third embodiment, the network access processing unit 150 first sends a request to the setting information download unit 210 to download setting information from a setting information server 80 that is specified by the network access processing unit 150 for radio LAN connection and for the pre-authentication of this invention, and the setting information download unit 210 stores the setting information obtained from the setting information server 80 in the parameter memory unit 180 and then notifies the network access processing unit 150 that the information has been stored, then using the information stored in the parameter memory unit 80, the network access processing unit starts radio LAN connection and the pre-authentication of this invention. The operation after pre-authentication starts is the same as the operation of the first embodiment and variation thereof.

In the operation of the radio terminal 10-3 of this third embodiment, the radio terminal 10-3 is already connected to a first base station, and is in a state in which data communication with a terminal that is connected to the network 40 is possible, and the radio terminal 10-3 of this third embodiment performs the operation of obtaining setting information by way of the setting information server 80 and the radio LAN communication interface unit 170 shown in FIG. 15.

Also, the radio LAN connection information for connecting to the first base station must be stored in the parameter memory unit 180 in advance.

In regards to the timing of the connection operation for connecting to the first base station, the operation of acquiring setting information from the setting information server 80 and the timing of the operation to start the pre-authentication of this invention does not necessarily need to be performed in succession. The assumed condition for each of the operations is that for the operation to connect to the first base station the information for connection must already be stored in the parameter memory unit 180, for the operation to acquire setting information from the setting information server 80 connection to the network must be complete, and for the timing of the operation to start the pre-authentication of this invention, the information for the base station that is the object of pre-authentication must already be stored in the parameter memory unit 180.

In other words, various timing as described below is feasible.

The radio terminal 10-3 of this third embodiment is connected to a first base station, and when at certain timing the network access processing unit 150 sends an acquisition request to acquire setting information from the setting information server 80, the setting information download unit 210 acquires setting information from the setting information server 80 and stores that information in the parameter memory unit 180, then notifies the network access processing unit 150 that the information has been stored. After that, at arbitrary timing, the network access processing unit 150 can use the information stored in the parameter memory unit 180 to start the pre-authentication operation of this invention.

As another example of timing, the radio terminal 10-3 is connected to a first base station, and when at certain timing the network access processing unit 150 sends an acquisition request to acquire setting information from the setting information server 80, the setting information download unit 210 acquires setting information from the setting information server 80 and stores that information in the parameter memory unit 180, then notifies the network access processing unit 150 that the information has been stored. After that, the network access processing unit 150 may start the pre-authentication operation of this invention after cutting the connection from the currently connected base station, and using the information acquired from the setting information server 80 to connect to a different base station.

In addition to the network connection information that includes the IP address of the base station that is the object of the pre-authentication, this third embodiment comprises means for acquiring network connection information for a base station to which the radio terminal 10-3 can connect, and only the method that uses this acquisition means differs from the operation of the radio terminal of the first embodiment, the variation thereof or the second embodiment, and the other operation is the same as the operation of the radio terminal of the first embodiment, the variation thereof or the second embodiment. Also, the construction and operation of the base stations 20, 30, the authentication server 50 and management server 60 are the same as in the first embodiment, the variation thereof or the second embodiment.

In this third embodiment, when the radio terminal 10-3 acquires setting information from the setting information server, HTTPS, by which mutual authentication is possible, can be used, and in that case, the user identification that is held by the radio terminal can be provided to the setting information server. Based on the user identification that is provided from the radio terminal, the setting information server can change the contents of the setting information to be returned, determine whether or not the setting information can be transferred, and return or not return the setting information.

Moreover, the third embodiment can be used in combination with the first embodiment, the variation thereof or second embodiment, and or can be used in combination with a combination of the first embodiment and second embodiment, or with a combination of the variation of the first embodiment and the second embodiment.

The effect of the third embodiment will be explained.

In this third embodiment, construction is such that information for connecting to a network that includes base stations that are and are not the object of pre-authentication (includes the IP address of base stations that are the object of pre-authentication) can be obtained from the setting information server by way of the network to which the radio terminal is currently connected, so network information for radio LAN connection can be dynamically obtained. Therefore, there is no need to set information for many base stations for connection in the radio terminal in advance, and since information is set dynamically, it is possible to reduce the nuisance of and setting errors that may occur in manual setting.

### Embodiment 4

Next, a fourth embodiment of the invention will be explained in detail with reference to the supplied drawings.

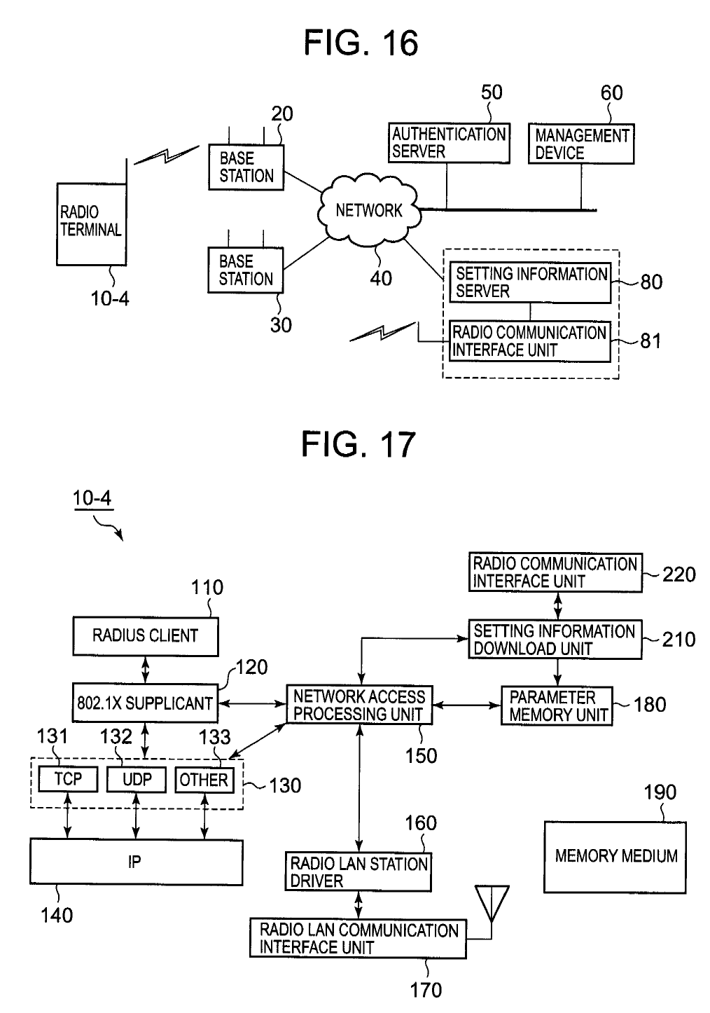

FIG. 16 is a drawing showing the construction of a radio communication system of a fourth embodiment of the invention.

In FIG. 16, the construction differs from the construction of the radio communication system of the third embodiment described above in that the setting information server 80 has an interface unit (infrared communication interface, visible light communication interface, Home RF communication interface, Bluetooth communication interface, or the like) 81 other than the wired LAN communication interface.

In addition to the setting information server of the third embodiment, the setting information server of the fourth embodiment has a radio communication interface unit (infrared communication interface, visible light communication interface, Home RF communication interface, Bluetooth communication interface, or the like) 81 other than a wired LAN communication wired LAN communication interface. In this fourth embodiment, only the operation of exchanging the setting information of the third embodiment with the radio terminal 10-4 by way of the radio communication interface unit 220 is different, and the other operation is the same as the operation in the third embodiment.

The setting information server 80 can be connected or not connected to the network 40 by way of the wired LAN communication interface.

In FIG. 17, the construction of the radio terminal 10-4 of the fourth embodiment differs in that in addition to the construction of the radio terminal 10-3 of the third embodiment (see FIG. 15), there is a radio communication interface unit 220 that is different than the radio LAN communication interface unit 170.

This fourth embodiment differs in that the exchange of setting information with the setting information server is performed by an operation of acquiring information by way of the radio communication interface unit 220 instead of by way of the radio LAN.

The setting information server 80 shown in FIG. 16 as well, similar to the radio terminal 10-4, replies to setting information acquisition requests from the radio terminal 10-4 by way of its own radio communication interface unit.

The operations of the network access processing unit 150 outputting an instruction to the setting information download unit 210 to download setting information, the setting information download unit 210 storing setting information that was acquired from the setting information server 80 in the parameter memory unit 210 and notifying the network access processing unit 150 that storage is complete, and using the information stored in the parameter memory unit 180 to perform radio LAN connection and start the pre-authentication of the invention, are the same as those operations in the third embodiment described above.

The operation of the radio terminal 10-4 of the fourth embodiment differs from the operation of the radio terminal 10-3 of the third embodiment described above in that setting information is acquired from the radio communication interface unit 220, so there is no need for the radio terminal 10-4 of the fourth embodiment to be connected by a radio LAN connection beforehand.

In addition to the network connection information that includes the IP address of the base station that is the object of the pre-authentication described above, only the aspect of using the radio communication interface unit 220 as an acquisition means for acquiring network connection information for base stations that the radio terminal 10-4 can connect to is different from the operation of the third embodiment described above, and the other operation is the same as that of the third embodiment. Also, the construction and operation of the base stations 20, 30, authentication server 50 and management device 60 are the same as those of the first embodiment and variation thereof, second embodiment and third embodiment.

This fourth embodiment can also be used in combination with any of the first embodiment or variation thereof, the second embodiment, and third embodiment, and can be used in combination with any combination of those.

Next, the effect of the fourth embodiment will be explained.

In this fourth embodiment, the radio terminal and setting information server are constructed so that they have a separate radio communication interface unit other than the radio LAN communication interface unit or wired LAN communication interface unit, so the exchange of setting information can be performed by way of a radio communication interface unit. Therefore, in the radio terminal, setting information can be obtained even when there is no radio LAN connection. Also, in the setting information server, by taking advantage of the properties of the communication interface unit, for example, in the case where communication is not possible within a certain specified range, by taking advantage of those properties, communication can be performed with just a specified radio terminal.

### Embodiment 5

Next, a fifth embodiment of the invention will be explained in detail with reference to the supplied drawings.

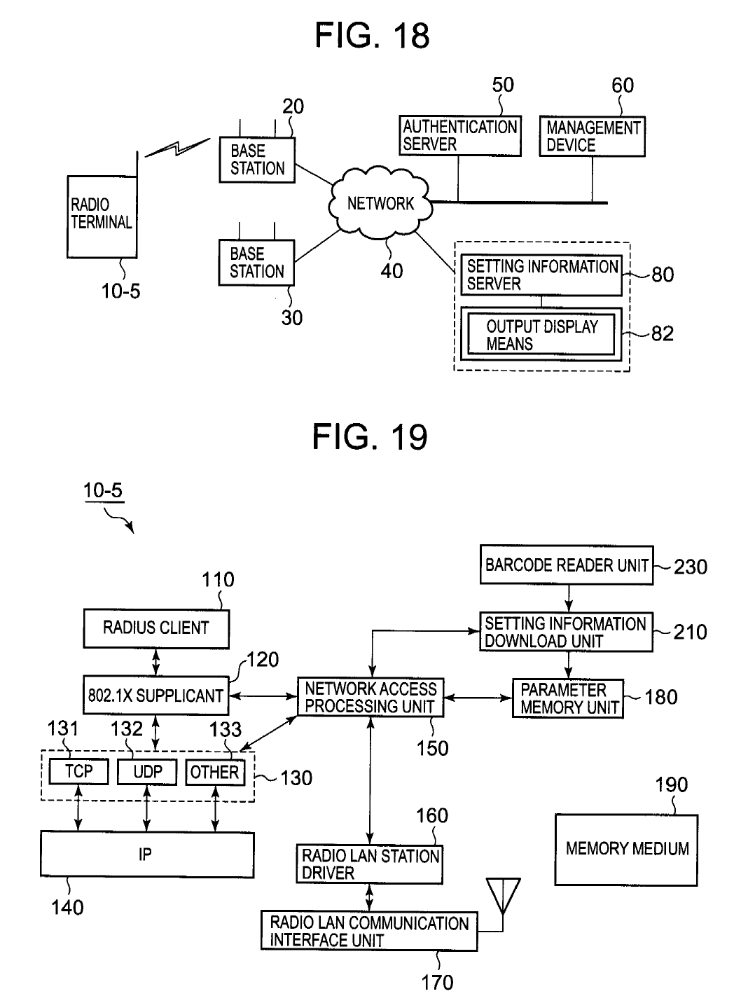

FIG. 18 is a drawing showing the construction of the radio communication system of a fifth embodiment of the invention.

In FIG. 18, the construction differs from the construction of the radio communication system of the fourth embodiment described above in that instead of the radio communication interface unit, the setting information server 80 has a barcode output display means 82 that includes the setting contents.

In addition to the setting information server of the third embodiment, the setting information server of this fifth embodiment has an output display means 82. In this fifth embodiment, only the operations of outputting the setting information of the third embodiment described above to the barcode output display means 82 of this fifth embodiment that includes the setting information, and reading the output results by the radio terminal are different, and the other operations are the same as those of the fourth embodiment.

The radio terminal 10-5 of this fifth embodiment differs from the radio terminal 10-4 of the fourth embodiment, in that the radio communication interface unit 220 is a barcode reader unit 230.

In FIG. 19, the construction of the radio terminal 10-5 of the fifth embodiment, when compared with the construction of the radio terminal 10-4 of the fourth embodiment, differs in that the radio communication interface unit 220 is a barcode reader unit 230. In the fifth embodiment, operation differs in that exchange of information with the setting information server is performed by way of the barcode reader unit 230 and not by way of the radio communication interface unit.

The setting information server 80 shown in FIG. 18 as well, similar to the radio terminal 10-5, provides setting information to the radio terminal 10-5 by way of its own barcode output display means 82 that includes the setting information contents.

The operations of the network access processing unit 150 outputting an instruction to the setting information download unit 210 to download setting information, the setting information download unit 210 storing setting information that was acquired from the setting information server 80 in the parameter memory unit 210 and notifying the network access processing unit 150 that storage is complete, and using the information stored in the parameter memory unit 180 to perform radio LAN connection and start the pre-authentication of the invention, are the same as those operations in the fourth embodiment described above.

Also, the operation after starting pre-authentication is the same as the operation in each of the embodiments described above.

The setting server 80 not only displays the barcode display result that include the contents of the setting information itself, but also, by transferring the results to a medium such as paper on which the result can be printed, it is possible to distribute the results regardless of where setting information server is located.

Also, this fifth embodiment can be used in combination with any of the other embodiments that have been described up until now, and can also be used in combination with any combination of those embodiments.

Net, the effect of the fifth embodiment will be explained.

In this fifth embodiment, construction is such that the radio terminal has a barcode reader unit, and the setting information server has a barcode output display means, so it is possible to use a medium on which a barcode that includes setting information can be recorded regardless of the location of the setting information server.

### Embodiment 6

Next, a sixth embodiment of the invention will be explained in detail with reference to the supplied drawings.

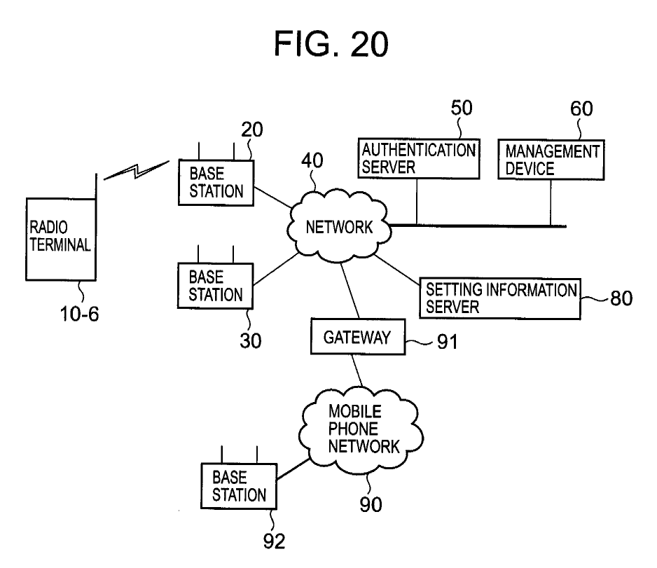

FIG. 20 is a drawing showing the construction of a radio communication system of this sixth embodiment of the invention.

In FIG. 20, construction differs from the construction of the radio communication system of the third embodiment (see FIG. 14) in that there is a mobile phone network 90, a gateway 91 that connects between the mobile phone network 90 and the Internet 40, and a base station 92 for connecting the radio terminal to the mobile phone network.

The mobile phone network 90 makes data communication possible in a closed network of the mobile phone network. In order to connect to the mobile phone network, it is necessary to access the network from the base station 92.

The gateway 91 is a gateway for making data communication between the mobile phone network 90 and the Internet 40 possible.

The base station 92 has a function as a base station the is necessary for accessing the mobile phone network 90, and it performs the function of relaying data communication between the radio terminal 10-6 that has a function for connecting to a mobile phone network and a device that is connected to the mobile phone network 90.

The radio terminal 10-6 of this sixth embodiment is different than the radio terminal 10-4 of the fourth embodiment described above in that the radio communication interface unit 220 of the radio terminal has a function for connecting to the mobile phone network 90 by way of the base station 92.

The operation of the radio terminal 10-6 of this sixth embodiment is the same as the operation of the radio terminal of the fifth embodiment described above. In other words, only the operation of obtaining setting information by way of a radio communication interface 220 that has a function for connecting to a mobile phone network is different, and all other operation is exactly the same.

A setting information acquisition request that is sent from the radio terminal 10-6 of this sixth embodiment passes over the mobile phone network 90 by way of the base station 92 and reaches the Internet 40 by way of the gateway 91, and finally reaches the setting information server 80. The setting information data that is returned to the radio terminal 10-6 is sent over the opposite path.

Also, this sixth embodiment can be used in combination with any of the other embodiments that have been described up until now, and can also be used in combination with any combination of those embodiments.

With this invention, in a radio LAN or wired LAN terminal or base station, the invention can be applied to a device for which authentication is necessary for connecting to the network before performing data communication by radio LAN, and thus is especially effective in a state where the terminal frequently moves among base stations.

1-24. (canceled)

25. A communication system that requires authentication from an authentication server when a radio terminal that is connected to a network by way of a first base station moves connection by way of a second base station in an IP sub network of a different broadcast domain, and when the radio terminal starts network connection by way of the second base station by having the radio terminal perform authentication of the second base station in advance over the network to which the radio terminal is connected, performs tunneling of an IP network by encapsulating an authentication frame of the authentication that is performed in advance into an IP packet so that part of the connection procedure is omitted.

26. The communication system of claim 25 wherein the second base station comprises means for performing tunneling of an IP network by encapsulating an authentication frame of the authentication that is performed in advance into an IP packet, and transfers the encapsulated IP packet for pre-authentication as is to an authentication server, and transfers an IP packet that is returned from the authentication server as is to the radio terminal.

27. The communication system of claim 26 wherein the second base station, which transfers the IP packet as is to the radio terminal, separates a PMK, which is sent from the authentication server together with an authentication successful notification, from the authentication successful notification and transfers only the authentication successful notification to the radio terminal.

28. The communication system of claim 25 or claim 27 wherein a radio terminal comprises means for performing tunneling of an IP network by encapsulating an authentication frame of the authentication that is performed in advance into an IP packet, and means for acquiring connection information for the second base station.

29. The communication system of claim 28 wherein means for acquiring connection information for the second base station acquires connection information from base station information that the radio terminal has itself.

30. The communication system of claim 28 or claim 29 wherein means for acquiring connection information for the second base station comprises a server that manages setting information for the second base station, and acquires setting information by communicating with the server that manages setting information for the second base station.

31. The communication system of claim 30 wherein means for acquiring connection information for the second base station communicates by way of a radio LAN communication interface.

32. The communication system of claim 30 wherein means for acquiring connection information for the second base station communicates by way of a radio communication interface other than a radio LAN communication interface.

33. The communication system of claim 30 wherein means for acquiring connection information for the second base station communicates by way of a radio communication interface having a connection function for connecting to a mobile phone network.

34. The communication system of any one of the claims 31 to 33 wherein the connection information is the IP address of the second base station.

35. The communication system of any one of the claims 31 to 33 wherein the connection information is information that is necessary for connection negotiation when connecting to the second base station.

36. A base station that: connects a radio terminal, which requires authentication by an authentication server, to a network when the radio terminal that is connected to a network by way of a first base station moves connection by way of a second base station in an IP sub network of a different broadcast domain; and when starting network communication with the radio terminal by having the radio terminal perform authentication beforehand by way of the currently connected network, performs tunneling of an IP network by encapsulating an authentication frame of authentication that is performed in advance into an IP packet so that part of the procedure for moving the connection is omitted.

37. The second base station of claim 36 that comprises means for tunneling of an IP network by encapsulating an authentication frame of the authentication that is performed in advance into an IP packet, and transfers the encapsulated IP packet for pre-authentication as an IP packet to an authentication server, as well as transfers an IP packet that is returned from the authentication server as an IP packet to the radio terminal.

38. A radio terminal that requires authentication by an authentication server when the radio terminal that is connected to a network by way of a first base station moves connection by way of a second base station in an IP sub network of a different broadcast domain, and that is capable of omitting part of the procedures for moving the connection when starting network communication by way of the second base station by performing authentication beforehand of the base station by way of currently connected network, and performs tunneling of an IP network by encapsulating an authentication frame of authentication that is performed in advance into an IP packet.

39. The radio terminal of claim 38 comprising: means for performing tunneling of an IP network by encapsulating an authentication frame of authentication that is performed in advance into an IP packet, and means for acquiring connection information for the second base station.

40. The radio terminal of claim 39 wherein the means for acquiring connection information for the second base station acquires base station information held by the radio terminal itself.

41. The radio terminal of claim 39 or claim 40 wherein the means for acquiring connection information for the second base station comprises a server that manages setting information for the second base station, and acquires setting information by communicating with the server that manages setting information for the second base station.

42. The radio terminal of claim 41 wherein the means for acquiring connection information for the second base station communicates by way of a radio LAN communication interface.

43. The radio terminal of claim 41 wherein the means for acquiring connection information for the second base station communicates by way of a radio communication interface other than a radio LAN communication interface.

44. The radio terminal of claim 43 wherein the means for acquiring connection information for the second base station communicates by way of a radio communication interface that has a function for connecting to a mobile phone network.

45. The radio terminal of any one of the claims 42 to 44 wherein the connection information is the IP address of the second base station.

46. The radio terminal of any one of the claims 42 to 44 wherein the connection information is information necessary for connection negotiation when connecting to the second base station.

47. A control method that is used in a communication system that requires authentication from an authentication server when a radio terminal that is connected to a network by way of a first base station moves connection by way of a second base station in an IP sub network of a different broadcast domain, and when the radio terminal starts network connection by way of the second base station, by having the radio terminal perform authentication of the second base station in advance over the network to which the radio terminal is connected, performs tunneling of an IP network by encapsulating an authentication frame of the authentication that is performed in advance into an IP packet so that part of the part of the procedures for moving the connection is omitted.

48. A program for a control method that is used in a communication system that requires authentication from an authentication server when a radio terminal that is connected to a network by way of a first base station moves connection by way of a second base station in an IP sub network of a different broadcast domain, and when the radio terminal starts network connection by way of the second base station, by having the radio terminal perform authentication of the second base station in advance over the network to which the radio terminal is connected, executes processing to perform tunneling of an IP network by encapsulating an authentication frame of the authentication that is performed in advance into an IP packet so that part of the part of the procedures for moving the connection is omitted.

49. The communication system of claim 25 wherein after receiving an authentication successful notice from the authentication server, the first base station can perform a 4-way handshake and group-key handshake in order to set a key for encoding data communication after that.

50. The base station of claim 36 wherein after performing notification that authentication from the authentication server was successful, the first base station can perform a 4-way handshake and group-key handshake in order to set a key for encoding data communication after that.

51. The control method of claim 47 wherein after performing notification that authentication from the authentication server was successful, the first base station can perform a 4-way handshake and group-key handshake in order to set a key for encoding data communication after that.

52. The program of claim 48 wherein after performing notification that authentication from the authentication server was successful, the first base station can perform a 4-way handshake and group-key handshake in order to set a key for encoding data communication after that.

53. The communication system of claim 25 wherein the first base station has an IEEE 802.11i based PMK cache function so that the PMK for each radio terminal for which authentication was successful once can be held, and when there is notification from the radio terminal during reconnection negotiation with that radio terminal that the PMK cache will be used, can suitably select and use a PMK from the held PMK.

54. The base station of claim 36 wherein the first base station has an IEEE 802.11i based PMK cache function so that the PMK for each radio terminal for which authentication was successful once can be held, and when there is notification from the radio terminal during reconnection negotiation with that radio terminal that the PMK cache will be used, can suitably select and use a PMK from the held PMK.

55. The control method of claim 47 wherein the first base station has an IEEE 802.11i based PMK cache function so that the PMK for each radio terminal for which authentication was successful once can be held, and when there is notification from the radio terminal during reconnection negotiation with that radio terminal that the PMK cache will be used, can suitably select and use a PMK from the held PMK.

56. The program of claim 48 wherein the first base station has an IEEE 802.11i based PMK cache function so that the PMK for each radio terminal for which authentication was successful once can be held, and when there is notification from the radio terminal during reconnection negotiation with that radio terminal that the PMK cache will be used, can suitably select and use a PMK from the held PMK.

57. The communication system of claim 25 wherein the radio terminal has an IEEE 802.1X specified supplicant function of so that the radio terminal can perform connection negotiation with the first and second base stations using a radio physical layer before data communication becomes possible.

58. The radio terminal of claim 38 wherein the radio terminal has an IEEE 802.1X specified supplicant function of so that the radio terminal can perform connection negotiation with the first and second base stations using a radio physical layer before data communication becomes possible.

59. The control method of claim 47 wherein the radio terminal has an IEEE 02.1X specified supplicant function of so that the radio terminal can perform connection negotiation with the first and second base stations using a radio physical layer before data communication becomes possible.

60. The program of claim 48 wherein the radio terminal has an IEEE, 802.1X specified supplicant function of so that the radio terminal can perform connection negotiation with the first and second base stations using a radio physical layer before data communication becomes possible.

61. The communication system of claim 25 wherein the radio terminal has an IEEE 802.11i based PMK cache function so that the PMK for base stations for which authentication was successful once can be held, and can send a notification during reconnection negotiation with the base station that the PMK cache will be used.

62. The radio terminal of claim 38 wherein the radio terminal has an IEEE 802.11i based PMK cache function so that the PMK for base stations for which authentication was successful once can be held, and can send a notification during reconnection negotiation with the base station that the PMK cache will be used.

63. The control method of claim 47 wherein the radio terminal has an IEEE 802.11i based PMK cache function so that the PMK for base stations for which authentication was successful once can be held, and can send a notification during reconnection negotiation with the base station that the PMK cache will be used.

64. The program of claim 48 wherein the radio terminal has an IEEE 802.11i based PMK cache function so that the PMK for base stations for which authentication was successful once can be held, and can send a notification during reconnection negotiation with the base station that the PMK cache will be used.
